(19) United States
(12) Patent Application Publication
(10) Pub. No.: US 2003/0014345 A1
(43) Pub. Date: Jan. 16, 2003

(54) Fully flexible financial instrument pricing system with intelligent user interfaces

(76) Inventor: Cheong Kee Jeffrey Lim, Singapore (SG)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/182,462

(22) PCT Filed: Jan. 26, 2001
(86) PCT No.: PCT/SG01/00010

(30) Foreign Application Priority Data
Jan. 28, 2000 (SG) 200000513-2

(51) Int. Cl. G06F 17/60

(52) U.S. Cl. 705/36

(57) ABSTRACT

The present risk management system with intelligent user interfaces divides all processes within the system into different “flowchart” phases. Decisions or inputs that can have knock-on effects on other decisions or inputs will be required at an earlier phase or level. If say, a particular decision or input has a knock-on effect on another decision or input, the system will require this decision or input to be entered at an earlier phase. This ensures a systematic and logical input of data as opposed to having all decisions or inputs appearing at the same time or in one phase, as in the case of other financial option and derivative pricing and structuring software programs. The system uses this “flowchart” process to provide an on-line guidance system for the users to input only the required decisions or inputs as they go along. As such, in adopting the intelligent user interface processing methodology, the user need not be an “expert” in knowing which inputs are required and which are not This system also minimizes user input errors.

### FIELD OF THE INVENTION

The present invention relates generally to the field of data processing systems for pricing and structuring financial instruments, and particularly to a fully flexible risk management system which provides user interfaces that intelligently guide the user and which allows the users to price and structure financial instruments which are not commonly found.

### BACKGROUND OF THE INVENTION

Individuals and enterprises are continually exposed to risk because of future events beyond their control. The outcome of those events can either positively or negatively impact on their well being. The kinds of risks often faced by those in the financial industries include: commodity prices, currency exchange rates, interest rates, property prices, share prices, inflation rates, company performance, and market event based indices. Although one can never completely protect oneself from such risks, financial and other types of institutions often hedge against an adverse outcome through various financial instruments such as futures contracts, forward contracts, and swaps, for instance. While not foolproof, the institutions can maximize their protection by correctly pricing and structuring the instruments.

The general mathematical methodology for pricing the various financial instruments are well known to those skilled In the art. Still, the actual process involved in the pricing activity is a complicated and tedious one. To assist in the calculation process, there currently exist many risk management systems which are typically used by banks and other corporations that engage in risk management activities. These systems help the user to price and structure various types of financial instruments such as forward rate agreements, swaps, caps, floors, etc. In order for these systems to properly price and structure the instruments, the user needs to carefully input various types of financial data which are used as parameters for the calculations.

Although the current risk management systems can successfully price the instruments, they are “expert” systems In the sense that the user must be fully knowlegeable about the pricing methodolgy to properly use the system. Typically, such a system would require that the user know and understand the correct types of inputs to enter. The system further requires that the user know where to input the Inputs and in what order. Because the system assumes that the user is fully knowledgeable about the pricing methodology, whatever input it receives is assumed to be correct, and no comprehensive checking is done to ensure that the input was not entered in error. An error during the input stage can lead to mis-calculation of the instrument which can obviously lead to adverse consequences for the institution relying on the information. Hence, the current systems are typically reserved for very selected individuals who are both knowledgeable and confident about using the risk management system.

In addition, current risk mangement systems have the further shortcoming in that they are very rigid systems where the they only allow the users to price and structure financial instruments that are commonplace in the financial markets. As financial systems are continually growing in importance and sophistication, there is a need for a risk management system which can accomodate to the emergence of new instruments, and particularly in a manner which is easy for users to use. However, currently, such a system is not available.

### OBJECT OF THE INVENTION

It is therefore the object of the present invention to provide a risk management system which overcomes the shortcomings of the prior art systems as described above to provide a fully flexible and user-friendly system.

### SUMMARY OF THE INVENTION

The present risk mangement system with intelligent user interfaces divides all processes within the system into different “flowchart” phases. Decisions or inputs that can have knock-on effects on other decisions or inputs will be required at an earlier phase or level. If say, a particular decision or input has a knock-on effect on another decision or input, the system will require this decision or input to be entered at an earlier phase. This ensures a systematic and logical input of data as opposed to having all decisions or Inputs appearing at the same time or in one phase, as in the case of the other financial option and derivative pricing and structuring software programs. The system uses this “flowchart” process to provide an on-line guidance system for the users to input only the required decisions or inputs as they go along. As such, in adopting the intelligent user interface processing methodology, the user need not be an “expert” in knowing which inputs are required and which are not. This system also minimizes user input errors.

In addition, the present system is fully flexible. Most financial derivatives and options pricing/structuring systems currently available in the market only allow users to price and structure financial instruments that are commonplace in the financial markets. The present system, on the other hand, has not been bound by current market instrument specifications or conventions, and has incorporated extended features that would enable users to price and structure fully flexible forward rate agreements, interest rate and cross currency swaps, caps, floors, digitals and/or combinations of any of the above as well as user-defined cashflows even before these instruments become available and commonplace in the financial markets.

### BRIEF DESCRIPTION OF THE DRAWINGS

FIG. 1 illustrates the overall menu structure of the present risk management system.

FIG. 2 is a flow diagram illustrating the general methodology employed by the present system when a user interacts with the system's user interfaces.

FIGS. 3 through 15 are user interfaces relating to the pricing of Regular Interest Rate Swap using the present system.

FIGS. 16 through 21 are user interfaces relating to the pricing of Exotic Interest Rate Swap using the present system.

FIGS. 22 through 28 are user interfaces relating to the pricing of Regular Cross Currency Swap using the present system.

FIGS. 29 through 36 are user interfaces relating to the pricing of Exotic Cross Currency Swap using the present system.

FIGS. 37 through 39 are user interfaces relating to the pricing of Exotic FRA whereby the Interest Mode is set to “Reverse Floating.”

FIGS. 40 through 42 are user interfaces relating to the pricing of Exotic FRA whereby the LIBOR currency Base is of a different currency from the Base Currency for the FRA.

FIGS. 43 through 45 are user interfaces relating to the pricing of Exotic Interest Rate whereby the Interest Mode is set to “Reverse Floating.”

FIGS. 46 through 49 are user interfaces relating to the pricing of Exotic Cross Currency Swap whereby the LIBOR Currency Base Is of a different currency from the Base Currency for a Swap Leg.

FIGS. 50 through 52 are user interfaces relating to the pricing of Exotic Cap whereby the LIBOR Currency Base is of a different currency.

FIG. 53 illustrates a sample USD bid/offer IRS yield curve generated by the present system.

FIG. 54 illustrates a sample USD bid/offer IRS discount factor curves generated by the present system.

FIG. 55 illustrates a sample SGD bid/offer IRS yield curve generated by the present system.

FIG. 56 illustrates a sample SGD bid/offer IRS discount factor curve generated by the present system.

FIG. 57 illustrates a sample SGD bid/offer CCS yield curve generated by the present system.

FIG. 58 illustrates a sample SGD bid/offer CCS discount factor curve generated by the present system.

FIGS. 59 through 73 are user interfaces relating to the pricing of Currency Option Structure.

### DETAILED DESCRIPTION OF THE INVENTION

As a way of clearly describing the present invention, the following definitions are provided. It should be understood, however, that the definitions are provided herein for clarification purposes only and should not be deemed as limiting the scope of the present invention.

Definitions “Swaps” is used to describe a generalized class of financial exchange transactions involving counter-parties simultaneously purchasing and selling their rights to streams of cashflows. The cashflows usually come in two categories, interest cashflow or principal cashflow, and they depend on several factors such as the Base Currency, Frequency, LIBOR Currency Base, and a number of other inputs. There will always be two legs to each swap transaction. If one leg of the swap transaction involves a counter-party receiving one type of cashflow (e.g. interest or principal), then the other leg would involve the same counter-party paying that same type of cashflow.

“User-defined Cashflows” is used to mean tailored cashflow structures that are fully definable by the user and not necessarily conforming to any well-known cashflow structures in the market place.

“Position” in the case of Swaps is used to mean the side taken by the user for each leg of the Swap. The two options available for “Position” are Receive and Pay. If the user has chosen “Pay” for one leg of the Swap, then his position for the other leg must be “Receive” — they are mutually exclusive. For the case of Receive, one chooses to receive the Indicated interest cashflows for that particular Swap Leg. For the case of Pay, one chooses to pay the indicated interest cashflows for that particular Swap Leg. In the case of Caps/Floors/Digitals, the user can choose either to Buy or Sell the instrument. In the case of financial option instruments, the user can choose to either buy or sell the instrument. “Base Currency” is used to mean the currency on which all cashflows for a particular Cashflow Leg will be based. “Spot Rate” is used to mean the current exchange rate for Currency 1 in Currency 2 terms, and in the interest rete derivative module, is used for the purpose of valuing the present value of Currency 1 cashflows in Currency 2 terms or the present value of Currency 2 cashflows in Currency 1 terms, so that all cashflows can be consolidated into one currency. In the currency option module, spot rate is used to mean the current level of the underlying. It is also used to relate the two base currency notional amounts. “Notional Amount” In the interest rate derivative module is used to mean “principal” amount (in the base currency) that will be used for the purpose of calculating all cashflows (including principal exchanges, if any; and all interest cashflows in that currency leg). In the currency options module context, it is used to mean the basic contract size for the option structure. “Start date” is used to mean the start date of the financial instrument, i.e., the date from which the instrument begins to be “active”. “End date” is used to mean the maturity date of the financial instrument, i.e., the date at which the instrument becomes “de-activated” and expires. “Expiry Date” in the currency options module is used to mean the date on which the options seize to exists. “Delivery Date” in the currency option module is used to mean the date the underlying will be delivered when an option is exercised. “Cashflow Frequency” is used to mean the frequency of the interest cashflow movements for a particular cashflow leg of the instrument, e.g., monthly, bimonthly, quarterly, semi-annually, and annually. “Stub Handling Procedure” is used to mean the procedure that is adopted for the handling of Stubs or “odd” period in a Cashflow Leg, i.e., where the “Stub” period should be. For instance, “Stub” can either appear at the beginning of all cashflows or at the end of all cashflows. “LIBOR” is used to mean the London Inter-bank Offer Rate and the rates quoted are often used by market participants to benchmark interest rates. “LIBOR Setting Time” only applies when the Interest Mode for the particular Cash-low Leg is set to Floating. It denotes the point in time when the LIBOR Setting takes place for interest calculation purposes. “Interest Movements” is used to mean the timing of interest movements. For instance, the interest movement can take place either at the beginning of the interest period or at the end of the interest period. “Interest Mode” is used to mean the mode of the interest that will be used for the purposes of interest calculations, e.g., fixed, floating, and reverse floating. “Business Day Convention” is used to mean the financial markets' convention applicable to the handling of holidays and non-business days. “DayCount Convention” is used to mean the financial markets' convention applicable to the counting of days in a given interest period and is used in the calculation of interest. “Notional Adjustments” denotes the amounts by which the Notional Principal is increased or decreased. “LIBOR Currency Base” only applies when the Interest Mode for a particular Cashflow Leg is set to Floating and is used to denote the currency of the LIBOR Floater. For example, if the benchmark floating rate to be used for the purposes of calculating interest is the 6-month Pound Sterling LIBOR Rate, then the LIBOR Currency Base in this case is Pound Sterling. “LIBOR Setting Basis” only applies when the Interest Mode for a particular Cashflow Leg is set to Floating and is used to denote the tenor of the LIBOR benchmark rate, e.g., Monthly (1-month LIBOR), Bi-Monthly (2-month LIBOR), Quarterly (3-month LIBOR), Semi-Annually (6-month LIBOR), Annually (12-month LIBOR). “Stub LIBOR Handling Procedure” Is used to mean the procedure that is used for the handling of interest calculations for the Stub or “odd” period in a Cashflow Leg. If the Standard Procedure is chosen, an approximation method is used to determine the LIBOR appropriate for the Stub Period, based on the tenor of the Stub Period (which is the normal market convention); alternatively, if Non-standard is chosen, then the chosen LIBOR Basis is used to determine the LIBOR for the Stub Period, ignoring the tenor of the Stub Period.

The Risk Management System

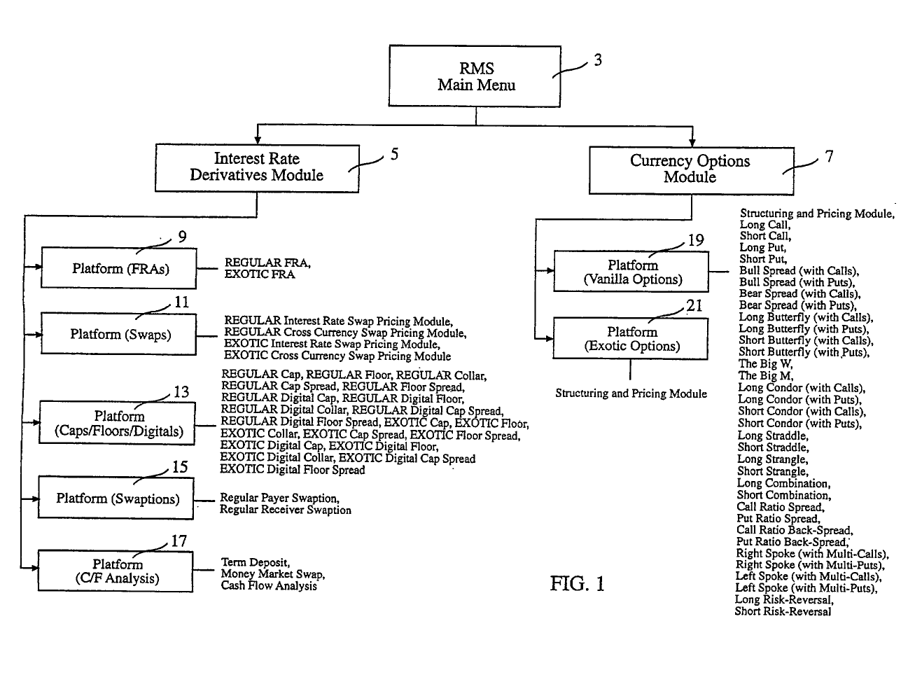

The present risk management system is a fully flexible and user-friendly system which prices and structures financial instruments. FIG. 1 illustrates the overall structure of the present risk management system (hereinafter “RMS”). Referring now to FIG. 1, the main menu 3 provides the user with the option to choose between Interest Rate Derivatives Module 5 and Currency Options Module 7. The Interest Rate Derivatives Module 5 is divided into five separate platforms: Platforms FRAs 9; Platform Swaps 11; Platform Caps/Floors/Digitals 13; Platform Swaptions 15; and Platform C/F Analysis 17. The Currency Options Module is divided into two separate platforms: Platform Vanilla Options 19; and Platform Exotic Options 21.

Still referring to FIG. 1, in each of the Platforms, several options or choices are available. In Platform FRAs 9, the choices are Regular FRA and Exotic FRA. In Platform Swaps, the choices are Regular Interest Rate Swap, Regular Cross Currency Swap, Exotic Interest Rate Swap, and Exotic Cross Currency Swap. In Platform Caps/Floors/Digitals 13, the choices are Regular Cap, Regular Floor, Regular Collar, Regular Cap Spread, Regular Floor Spread, Regular Digital Cap, Regular Digital Floor, Regular Digital Collar, Regular Digital Cap Spread, Regular Digital Floor Spread, Exotic Cap, Exotic Floor, Exotic Collar, Exotic Cap Spread, Exotic Floor Spread, Exotic Digital Cap, Exotic Digital Floor, Exotic Digital Collar, Exotic Digital Cap Spread, Exotic Digital Floor Spread.

Still referring to FIG. 1, in Platform Swaptions 15, the choices are Regular Payer Swaption and Regular Receiver Swaption. In Platform C/F Analysis 17, the choices are Term Deposit, Money Market Swap, and Cash Flow Analysis. In Platform Vanilla Options 19, the choices are Structuring and Pricing, Long Call, Short Call, Long Put, Short Put, Bull Spread (with Calls), Bull Spread (with Puts), Bear Spread (with Calls), Bear Spread (with Puts), Long Butterfly (with Calls), Long Butterfly (with Puts), Short Butterfly (with Calls), Short Butterfly (with Puts), The Big W, The Big M, Long Condor (with Calls), Long Condor (with Puts), Short Condor (with Calls), Short Condor (with Puts), Long Straddle, Short Straddle, Long Straddle, Short Strangle, Long Combination, Short Combination, Call Ratio Spread, Put Ratio Spread, Call Ratio Back-Spread, Put Ratio Back-Spread, Right Spoke (with Multi-Calls), Right Spoke (with Multi-Puts), Left Spoke (with Multi-Calls), Left Spoke (with Multi-Puts), Long Risk-Reversal, and Short Risk-Reversal. In Platform Exotic Options 21, the only choice at the moment is the Structuring and Pricing Module.

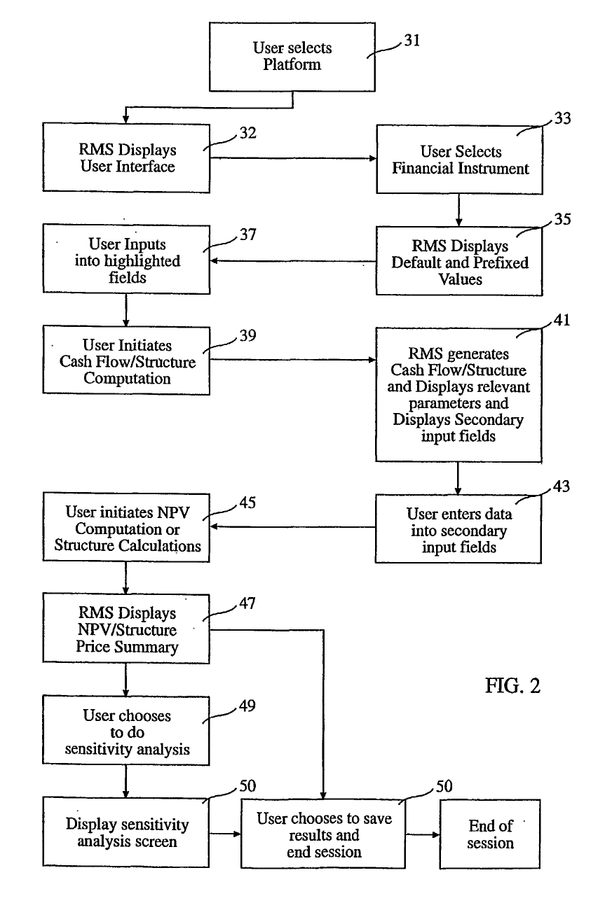

For each of the Platforms shown in FIG. 1, an intelligent interactive user interface is provided which guides the user. The present interface allows the user to input the necessary data in a systematic manner. Moreover, it prevents the user from entering the data at the wrong location or at the wrong point in time. The process flow illustrating the interaction between a user and the RMS via the interactive interface for the regular instruments (non-exotic) is shown in FIG. 2.

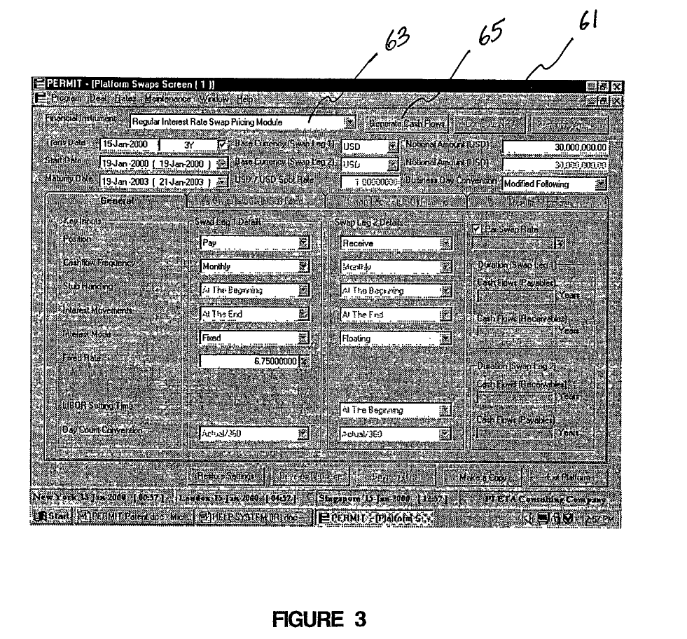

Referring now to FIG. 2, the user first chooses the type of platform in step 31, e.g. Platform Swaps. In step 32, the RMS displays the user interface. An example of the user interface 61 is shown in FIG. 3. Referring now to FIGS. 2 and 3, on the user interface, a field, 63, is provided which lists the type of financial instruments available for the particular platform chosen, and the user selects the type of financial instrument in step 33 which is available for that particular platform. The RMS displays the primary input fields, and places a default or pre-fixed value for each of the fields. The default and pre-fixed values vary depending on the platform and the type of financial instrument chosen. The pre-fixed values are not highlighted (shown as light gray) and cannot be changed by the user, while the default values are highlighted (shown in dark lines) and can be changed by the user. In step 37, the user inputs the data which are specific to his situation into the highlighted fields.

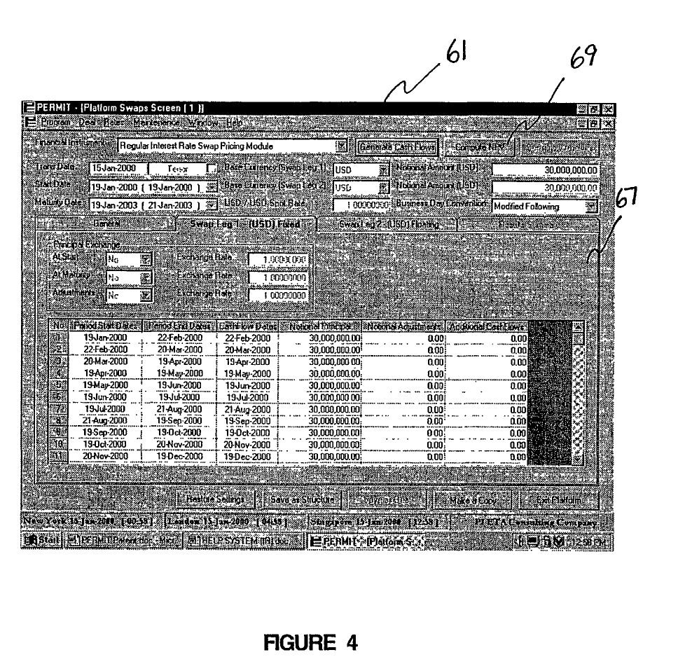

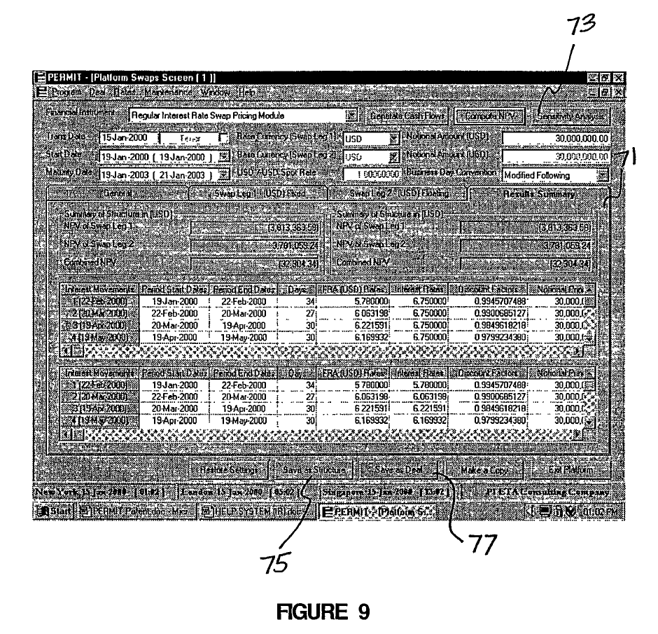

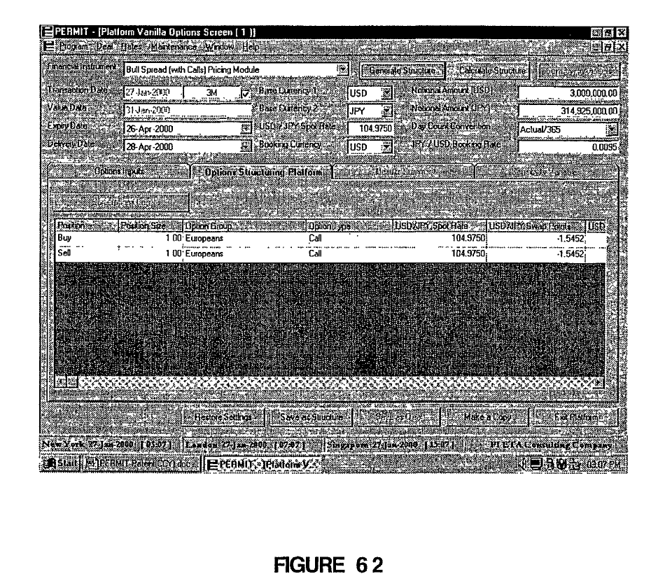

Still referring to FIGS. 2 and 3, once the user has entered all of the necessary data into the highlighted fields, the user initiates the cash flow computation by pressing the “Generate Cash Flows” button 65 in step 39 if the computation is related to the interest rate derivatives module Alternatively, if the computation is related to currency options module, then the user initiates the structure computation by pressing the “Generate Structure” button (not shown, but for currency platforms, the “Generate Cash Flow” button would be replaced with “Generate Structure” button, see FIG. 62). In step 41, the RMS generates the cash flow or the structure (depending on whether interest or currency is chosen) and displays the relevant parameters on the interface 61 and fields for the secondary input fields (which vary from Instrument to instrument) as shown in FIG. 4. The user enters the data into the secondary input fields per his specific needs in step 43. The user then initiates the NPV computation or structure calculations (again, depending on whether interest rate module or currency module is chosen) by pressing on the appropriate button, e.g. Compute NPV 69, in step 45. In step 47, the RMS displays the NPV (or structure) summary on the interface 71 as shown in FIG. 9. Thereafter, the user can choose to save the results and end the session in step 51. Alternatively, the user can choose to do sensitivity analysis first by pressing the “Sensitivity Analysis” button 73 which is highlighted only after the NPV or structure has been calculated. In step 50, the RMS displays the sensitivity analysis screen 75.

Thereafter, the user goes to step 51. In step 51, the user has two types of saving option: save as structure, 75, or save as deal, 77. “Save as Deal” completes the transaction and prevents any modification to the structure; “Save as Structure” saves the structure of the instrument and allows future modifications.

The following examples 1 through 3 are presented herein to better illustrate the process shown in FIG. 2. It should be understood, however, that the examples are illustrative only, and not be construed as limiting the present invention to the particularities shown in the examples.

### EXAMPLE 1

Suppose a user wishes to structure and price the following Regular Interest Rate Swap using RMS. It should be noted that Interest Rate Swaps are financial swap transactions involving only interest rate cashflows. No principal cashflows are involved. In a regular Interest Rate Swap, the Base Currencies of both legs of the Swap are the same, and the LIBOR Currency Base is the same as the Base Currency. In addition, regular interest rate swaps have the LIBOR Basis chosen such that it matches the cashflow frequency.

Swap Details: 3-year Regular U.S. Dollar (USD) Interest Rate Swap (IRS) whereby on a Monthly basis, the user pays Fixed USD interest at 6.75% p.a. and receives Floating USD interest based on the 1-month USD LIBOR (London Inter-bank Offer Rate) benchmark rate. The Notional Amount of the IRS is initially set at USD 30 million, and this amount reduces by USD 10 million at the end of the first year to USD 20 million. The Notional Amount is further reduced by USD 10 million at the end of the second year to USD 10 million.

The user first chooses the Platform Swaps Module which takes the user to the Platform Swaps Screen (see FIG. 3). The user then has to select “Regular Interest Rate Swap Pricing Module” from the Financial Instrument Drop-down List. Once this is selected, RMS automatically “forces” or pre-sets certain settings that pertain to regular Interest Rate Swaps, thus facilitating the input process. Regular Interest Rate Swaps are generally the interest rate swaps commonly transacted in the financial market place. Certain common identifiable features are present in such swaps and can hence be pre-set or pre-determined. For example, the pre-selectable inputs are: Base Currency (Leg 2) to be set to Base Currency (Leg 1), Notional Amount (Leg 2) to be set to Notional Amount (Leg 1), Interest Movements to take place only at The End of each Interest Period, LIBOR Setting Time to be at The Beginning of each Interest Period, LIBOR Currency Base to be set to the Base Currency, the LIBOR Basis to be set to follow Cashflow Frequency, the Stub LIBOR Handling Procedure to be set to the Standard Procedure, and the DayCount Convention to be set to the DayCount Convention of the underlying Base Currency.

Next, the user then enters “3Y” In the Tenor Box, to indicate that the IRS is of a 3-year tenor. RMS automatically fills in the corresponding Start and Maturity Dates (these dates can be overwritten by the user if need be, i.e., RMS allows its user the flexibility to choose unconventional dates). The user now chooses USD as the Base Currency (Swap Leg 1) from the Drop-down List. Notice that RMS automatically sets the Base Currency of Swap Leg 2 to USD since the financial instrument chosen is an IRS. Following this, the user enters 30,000,000 as the Notional Amount to start with. Business Day Convention is chosen to be “Modified Following”—the usual market convention to adopt for such Swaps. Moving down the interface 61, the user then provides inputs that have not been “frozen out” or pre-selected.

It is important to note that the “Dynamic” drop-down lists are provided wherever possible as part of the intelligent interface. The input fields or boxes are of a “dynamic” nature too, i.e., they appear only when required. In order to minimize user input errors, certain parameters have been pre-set by RMS. As part of the intelligent interface adopted by RMS, only the “Generate Cash Flows” button at the top right-hand side of the screen is active. The other two buttons on the right are de-activated. Also, note that the Swap Leg 1—(USD) Fixed and the Swap Leg 2—(USD) Floating Tab-sheets are “rozen” as the inputs on these Tab-sheets are only required at the second phase of the pricing process. This is done to ensure that the processing is carried out through a logical “flowchart” input and output system. At the bottom of the screen, the “Save as Structure” and “Save as Deal” buttons are inactive at this stage. The user Is not allowed to save the settings as either a structure or a deal since the whole pricing and structuring process has not been completed at this stage. The other buttons are active as they do not affect the process.

When the first phase of inputs has been completed, and the “Generate Cash Flows” button is clicked once, the program takes the user to the secondary inputs (see FIG. 4). Notice that since the structure is an IRS, no principal exchanges are necessary, hence as part of the input pre-selection process, Principal Exchanges at Start, at Maturity and Adjustments have been set to “NO”.

It Is important to note that as part of the intelligent interface system adopted by RMS, notice that the “Compute NPV” button at the top right hand-side of the screen is now also active. The third button remains inactive. Notice that the Tab-sheets, Swap Leg 1—(USD) Fixed and the Swap Leg 2—(USD) Floating, are now open to the user as the inputs on these Tab-sheets are required at the second phase. Also, in order to minimize user input errors, RMS pre-sets the parameters in the Principal Exchange Box.

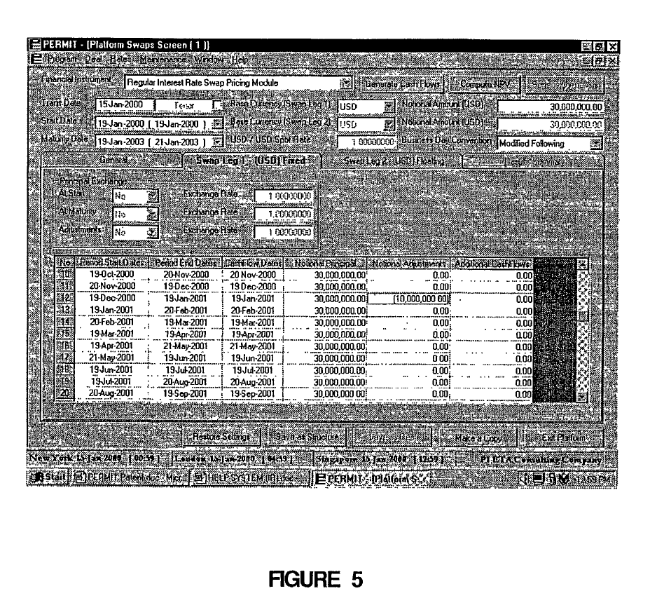

Still referring to FIG. 2, RMS has automatically generated the relevant Period Start and End Dates, together with the corresponding cashflow dates (see first three columns of Tab-sheet Swap Leg 1—(USD) Fixed). Notice however, that the Notional Amounts are all set at 30,000,000. Our desired structure is such that the Notional Amount is to be reduced by 10,000,000 to 20,000,000 at the end of the first year. This is dealt with in the next step (see the Notional Adjustments Column appearing on the Tab-sheet, Swap Leg 1—(USD) Fixed in FIG. 5).

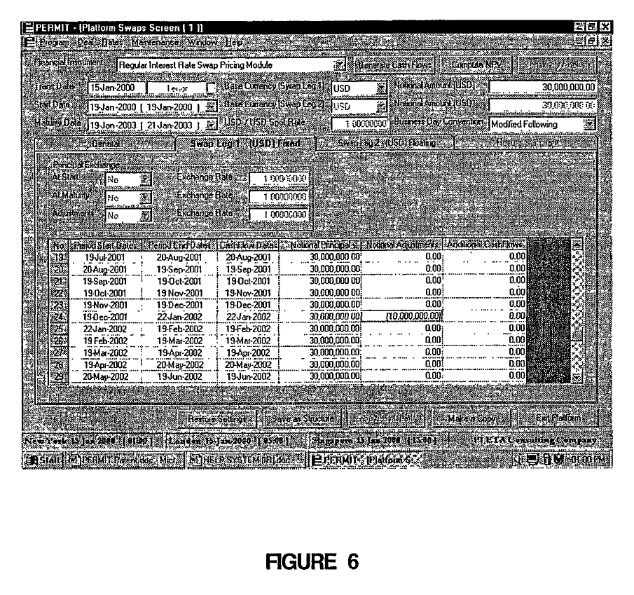

Our desired structure also requires the Notional Amount to be further reduced by 10,000,000 to 10,000,000 at the end of the second year. This is dealt with in the following step (see the Notional Adjustments Column appearing on the Tab-sheet, Swap Leg 1—(USD) Fixed in FIG. 6).

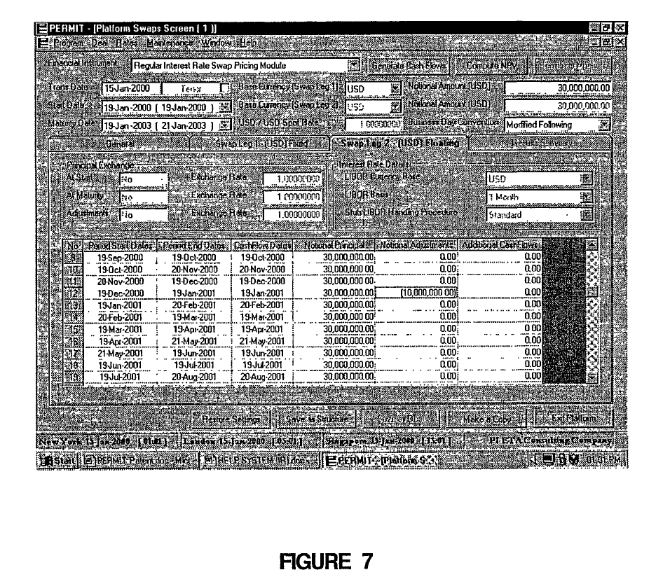

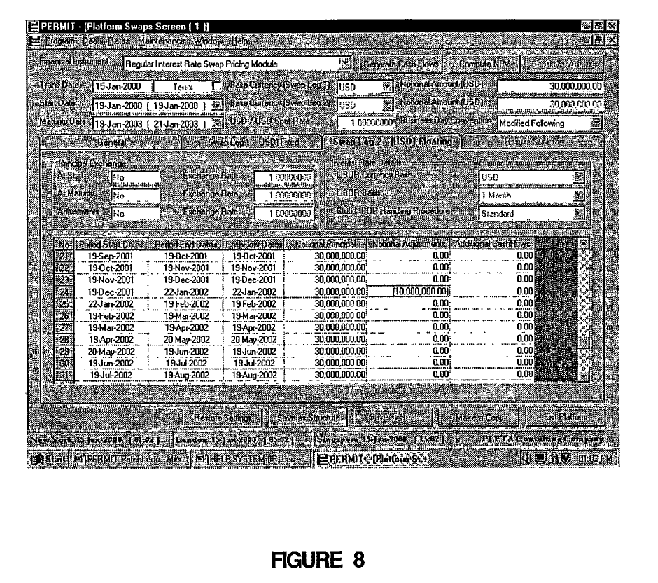

The above steps have only taken care of reducing the Notional Amounts for Swap Leg 1. Our “Regular” structure requires that we also reduce the Notional Amounts for Swap Leg 2 (see the Notional Adjustments Column appearing on the Tab-sheet, Swap Leg 2—(USD) Floating in FIGS. 7 & 8).

As part of the intelligent user interface adopted by RMS, notice (from FIG. 3) that since Leg 1 of the Swap is of a Fixed Interest Rate nature, i.e., the Interest is already fully determinable without further input, the “Interest Rate Details” input box does not appear on the Swap Leg 1—(USD) Fixed Tab-sheet. On the other hand, as Leg 2 of the Swap is of a Floating Interest Rate nature, further inputs are required, RMS prompts this by showing the “Interest Rate Details” input box on the Swap Leg 2—(USD) Floating Tab-sheet (compare FIGS. 5 and 7). Since this is a Regular Interest Rate Swap, the required inputs for an IRS have been pre-set. If this were an Exotic Interest Rate Swap, the required inputs would not be pre-set and the user would be required to provide these inputs.

Once ALL the required inputs have been entered, the user then clicks on the “Compute NPV” button. RMS continues with the process and provides the user with the outputs that appear on the “Results Summary” Tab-sheet (see FIG. 9). In this example, the numbers show that the Combined NPV of the Swap structure sets the user back by around USD 32,000. This is sometimes known as the “transaction cost” of the swap, or from the bankers' perspective, the spread income.

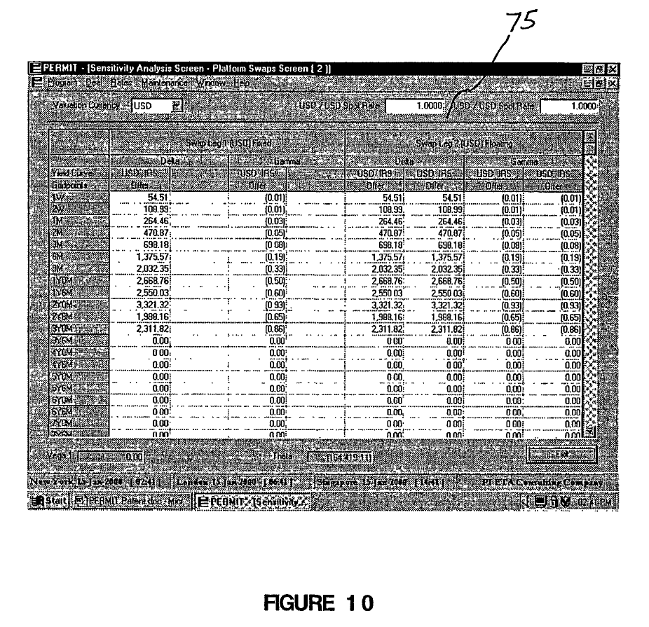

As part of the intelligent user interface adopted by RMS, note that at the top right-hand-side of the screen, the “Sensitivity Analysis” button is now finally active. Clicking on this button takes the user to a Sensitivity Analysis Screen (see FIG. 10) that displays certain sensitivity analysis results indicating to the user how changes in the Yield Curve will affect the pricing of this structure. At this stage, the structure is now fully described and if it had been dealt, the user can now have the option of saving the structure as a deal by clicking on the now activated “Save as Deal” button at the bottom of the screen.

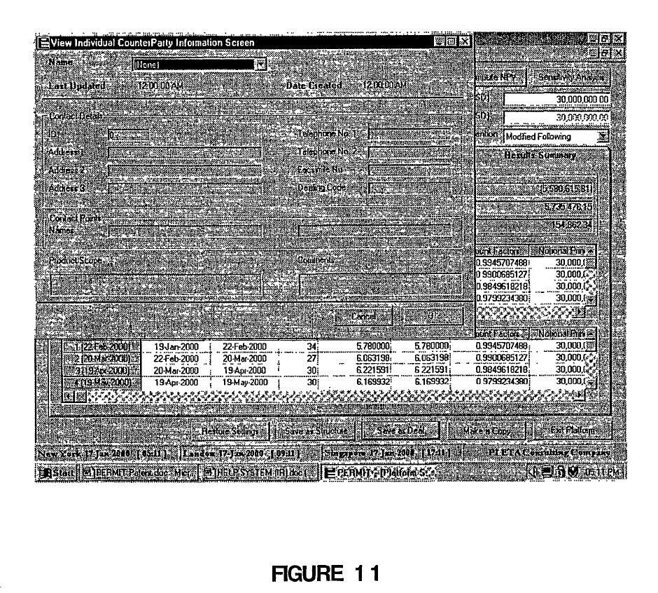

As part of the intelligent user interface adopted by RMS, if the user should choose to save the structure as a Deal done, RMS will require further information about the Swap CounterParty before allowing the details to be stored as a Deal in the database. At this point, RMS will prompt the user with a pop-up-“View Individual CounterParty Information” Screen (see FIG. 11).

The user can choose the Counterparty from the Drop-down list of existing active counterparties.

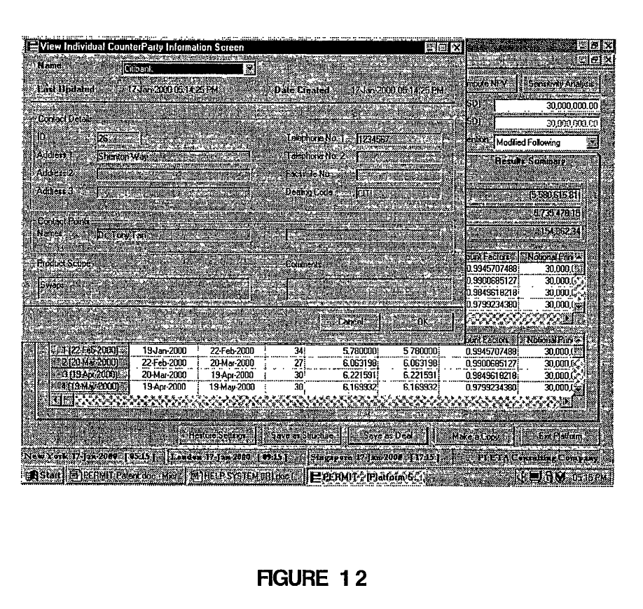

Once the Counterparty is chosen, RMS auto-fills the various fields relating to Counterparty Details information (see FIG. 12), and the deal can now be saved by clicking on the “/OK” button.

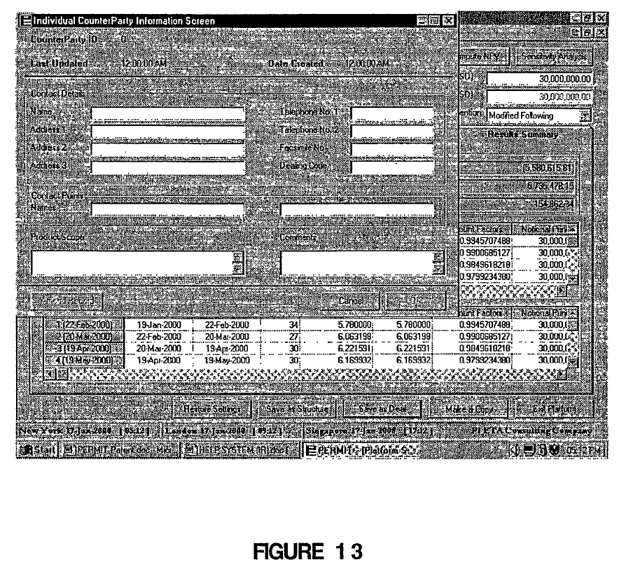

If the Counterparty Name is not on the Drop-down list of existing active counterparties, the user should choose the New Counterparty option and a new pop-up screen will appear for the user to input the details of the new counterparty (see FIG. 13).

Once the Counterparty information has been entered into RMS, all information about the deal is complete. The structure can now be saved as a Done Deal and ALL the information provided will be stored as a Deal in the database. RMS then automatically prints a hard copy of the Deal Report containing ALL the deal details.

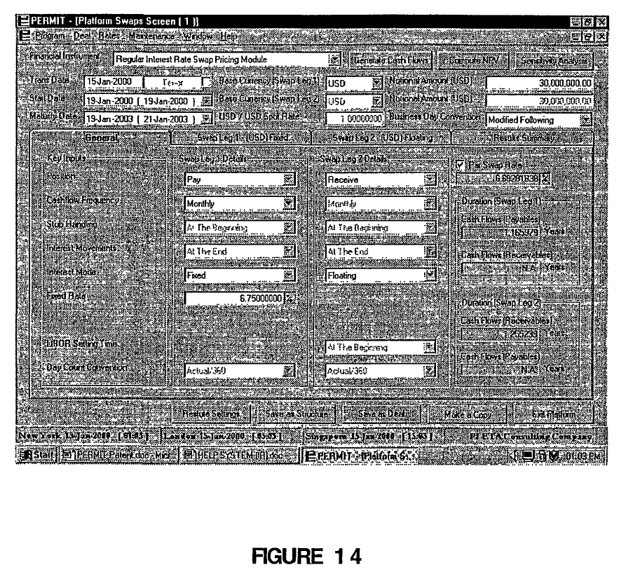

The user is free to toggle between the Tab-sheets. For example, if the user were to toggle back to the General Tab-sheet, one will notice the displayed Par Swap Rate (which is the “bank” or market rate without any spreads built in) for comparison purposes, and Duration displays for analysis purposes (see FIG. 14).

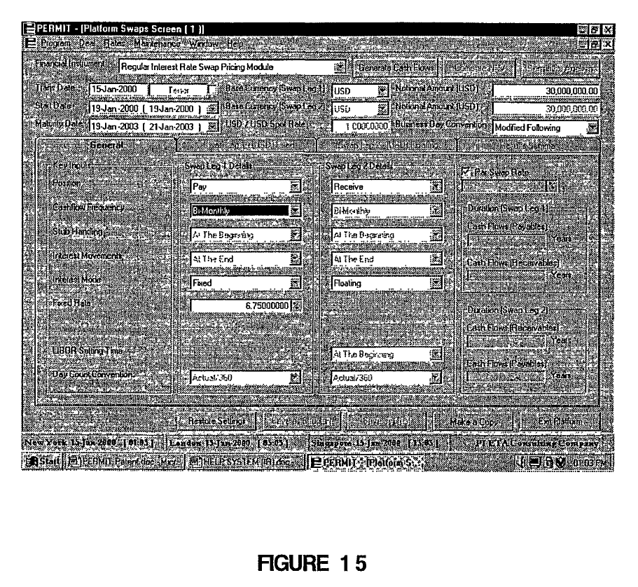

As a “safety” feature and to prevent possible mix-ups and errors, If for some reason the user changes any primary inputs at any stage of the pricing and structuring process, RMS automatically returns the user to the primary input level, freezing all buttons and tab-sheets pertaining to other input phases. To illustrate, suppose the user in the previous example changes the Cashflow Frequency from “Monthly” to “Bi-Monthly”. When this happens, RMS immediately returns the user to the primary Input Level (see FIG. 15). The user will then be required to go through all the different phases of inputs to structure and price the resulting new product.

### EXAMPLE 2

Suppose a user wishes to structure and price the following Regular Cross Currency Swap using RMS.

Swap Details: 3-year Regular U.S. Dollar (USD)/Singapore Dollar (SGD) Cross Currency

Swap (CCS) whereby on a Bi-monthly basis, the user pays fixed USD interest at 7.10% p.a.

and receives floating SGD interest based on the 2-month SGD LIBOR benchmark rate. The

Notional Amount of the CCS is initially set at USD 10 million, and this amount reduces by

USD 5 million at the end of the first year to USD 5 million.

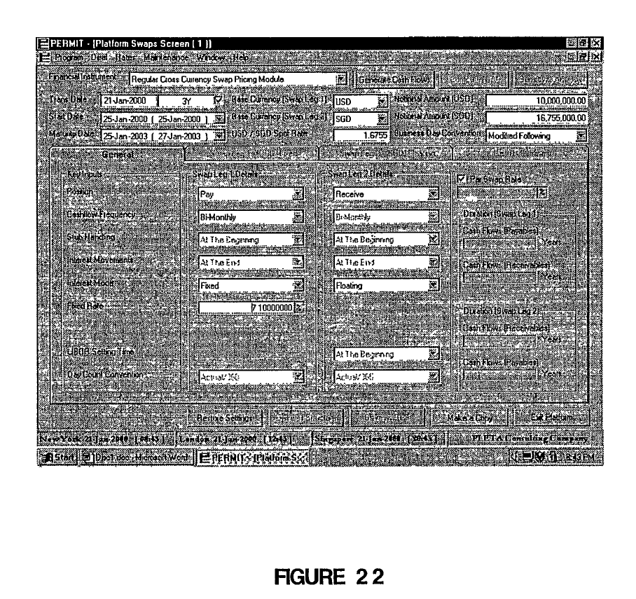

The user first chooses the Platform Swaps Module which takes the user to the Platform Swaps Screen. The user then has to select “Regular Cross Currency Swap Pricing Module” from the Financial Instrument Drop-down List (see FIG. 22). Once this is selected, RMS automatically “forces” or pre-sets certain settings that pertain to regular Cross Currency Swaps, thus facilitating the input process.

Next, the user then enters “3Y” in the Tenor Box to indicate that the CCS is of a 3-year tenor. RMS automatically fills in the corresponding Start and Maturity Dates (these dates can be overwritten by the user if need be, i.e., RMS allows its user the flexibility to choose unconventional dates). The user now chooses USD as the Base Currency (Swap Leg 1) and SGD as the Base Currency (Swap Leg 2) from the respective Drop-down Lists. Notice that RMS has not automatically set the Base Currency of Swap Leg 2 to USD and frozen the input field since the instrument chosen is a CCS. Following this, the user enters 10,000,000 as the Notional Amount to start with. Business Day Convention is chosen to be “Modified Following”—the usual market convention to adopt for such Swaps. Moving down the Screen, the user then provides inputs that have not been “frozen out” or pre-selected.

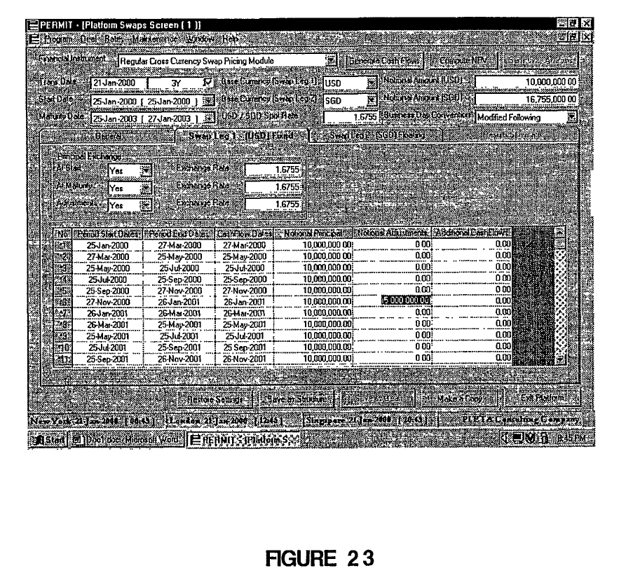

When the first phase of inputs has been completed, and the “Generate Cash Flows” button is clicked once, the program takes the user to the second phase of inputs (see FIG. 23). Notice that since the structure is a CCS, principal exchanges may be necessary, hence as part of the input pre-selection process, Principal Exchanges at Start, at Maturity and Adjustments have been defaulted to “YES” and can be changed by the user to “NO”.

Note that the “Compute NPV” button at the top right hand-side of the screen is now also active. The third button remains inactive. Notice that the Tab-sheets, Swap Leg 1—(USD) Fixed and the Swap Leg 2—(SGD) Floating, are now open to the user as the inputs on these Tab-sheets may be required at the second phase.

Referring to FIG. 23, RMS has automatically generated the relevant Period Start and End Dates, together with the corresponding cashflow dates (see first three columns of Tab-sheet Swap Leg 1—(USD) Fixed). Notice however, that the Notional Amounts are all set at 10,000,000. Our desired structure is such that the Notional Amount is to be reduced by 5,000,000 to 5,000,000 at the end of the first year. This is dealt with in the next step (see the Notional Adjustments Column appearing on the Tab-sheet, Swap Leg 1—(USD) Fixed in FIG. 23).

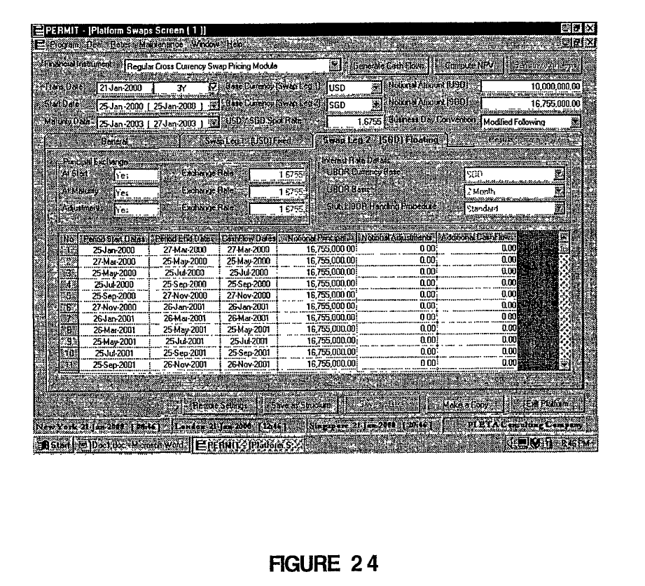

Once we have completed the above input step, we move on to the Tab-sheet, Swap Leg 2—(SGD) Floating in FIG. 24). Since the Principal Exchange Adjustments field is set to “YES”, RMS will automatically “take care of” the corresponding Notional Adjustment for Leg 2. In other words, no “action” needs to be taken here.

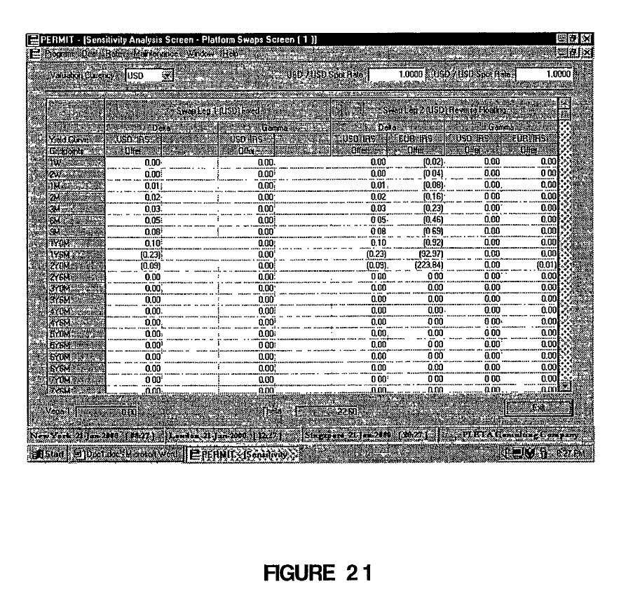

Note from FIG. 23 that since Leg 1 of the Swap is of a Fixed Interest Rate nature, i.e., the Interest Is already fully determinable without further input, the “Interest Rate Details” input box does not appear on the Swap Leg 1—(USD) Fixed Tab-sheet. On the other hand, as Leg 2 of the Swap is of a Floating Interest Rate nature, further inputs are required, RMS prompts this by showing the “Interest Rate Details” input box on the Swap Leg 2—(SGD) Floating Tab-sheet (compare FIGS. 21 and 22). Since this is a Regular Cross Currency Swap, the required inputs for a CCS have been pre-set. If this were an Exotic Cross Currency Swap, the required inputs would not be pre-set and the user would be required to provide these inputs.

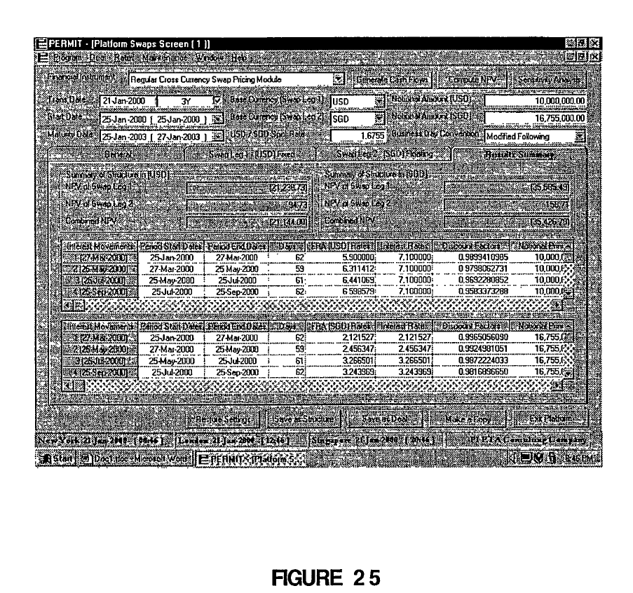

Once ALL the required inputs have been entered, the user then clicks on the “Compute NPV” button. RMS continues with the process and provides the user with the outputs that appear on the “Results Summary” Tab-sheet (see FIG. 25). In this example, the numbers show that the Combined NPV of the Swap structure sets the user back by around USD 21,000. This is sometimes known as the “transaction cost” of the swap, or from the bankers' perspective, the spread income.

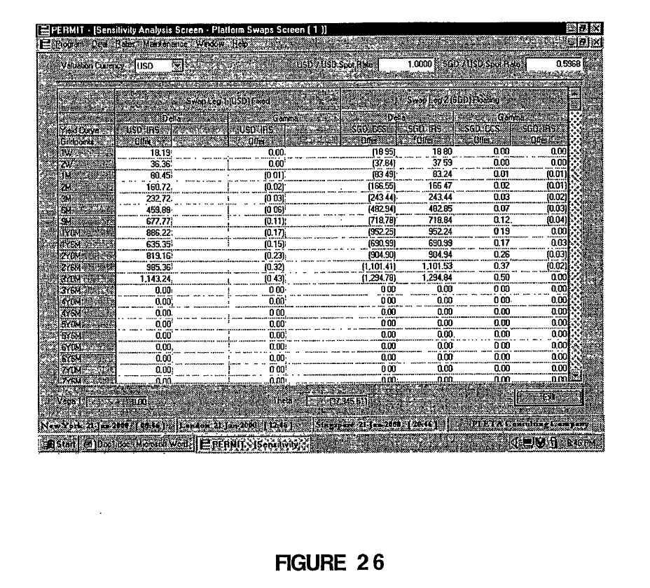

Note that at the top right-hand-side of the screen, the “Sensitivity Analysis” button is now finally active. Clicking on this button takes the user to a Sensitivity Analysis Screen (see FIG. 26) that displays certain sensitivity analysis results indicating to the user how changes in the Yield Curve will affect the pricing of this structure. At this stage, the structure is now fully described and if it had been dealt, the user can now have the option of saving the structure as a deal by clicking on the now activated “Save as Deal”) button at the bottom of the screen. The user can choose to save the structure as a Deal done or as a Structure, or he can choose not to save the structure at all. In this case, the user chooses not to save the structure.

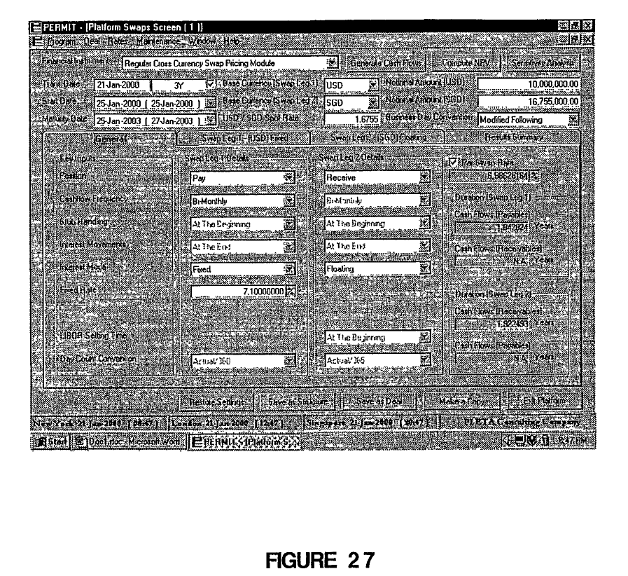

The user Is free to toggle between the Tab-sheets. For example, if the user were to toggle back to the General Tab-sheet, one will notice the displayed Par Swap Rate (which is the “bank” or market rate without any spreads built in) for comparison purposes, and Duration displays for analysis purposes (see FIG. 27).

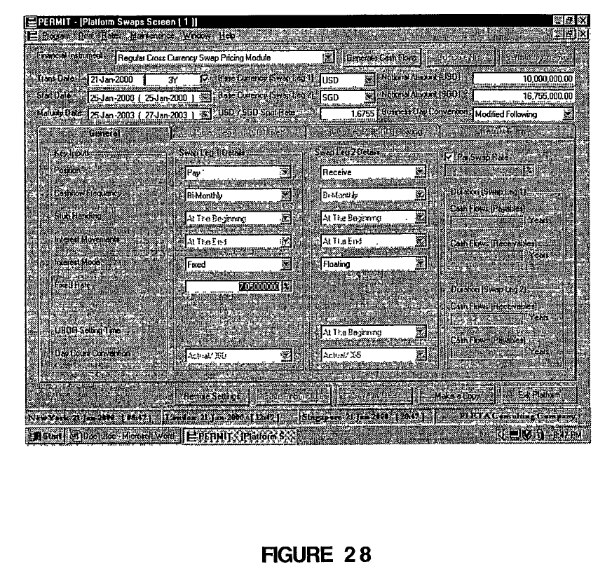

As a “safety” feature and to prevent possible mix-ups and errors, if for some reason the user changes any primary inputs at any stage of the pricing and structuring process, RMS automatically returns the user to the primary input level, freezing all buttons and tab-sheets pertaining to other input phases. To illustrate, suppose the user in the previous example changes the Fixed Rate from “7.10%” to “7.05%”. When this happens, RMS immediately returns the user to the primary input level (see FIG. 28). The user will then be required to go through all the different phases of inputs to structure and price the resulting new product.

### EXAMPLE 3

Suppose a user wishes to structure and price the following Currency Option Structure using RMS.

Option Structure Details:

Buy a 3-month U.S. Dollar (USD)/ Japanese Yen (JPY) Bull Spread (using Call Options). Notional Amount: USD 3 million. Strikes: 100.00/108.00.

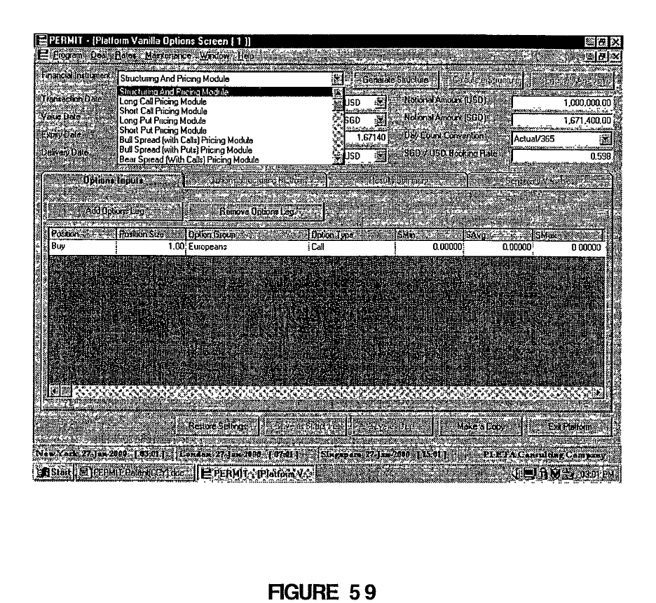

The user first chooses the Platform Vanilla Options Module which takes the user to the Platform Vanilla Options Screen (see FIG. 59). The user then has to select “Bull Spread (With Calls) Pricing Module” from the Financial Instrument Drop-down List. Once this is selected, RMS automatically “forces” or pre-sets certain settings that pertain to Bull Spread (with Calls) structure, thus facilitating the input process. In addition to this, RMS guides the user by highlighting the other required inputs (those appearing on the Tab-sheets), thus providing further guidance to the user.

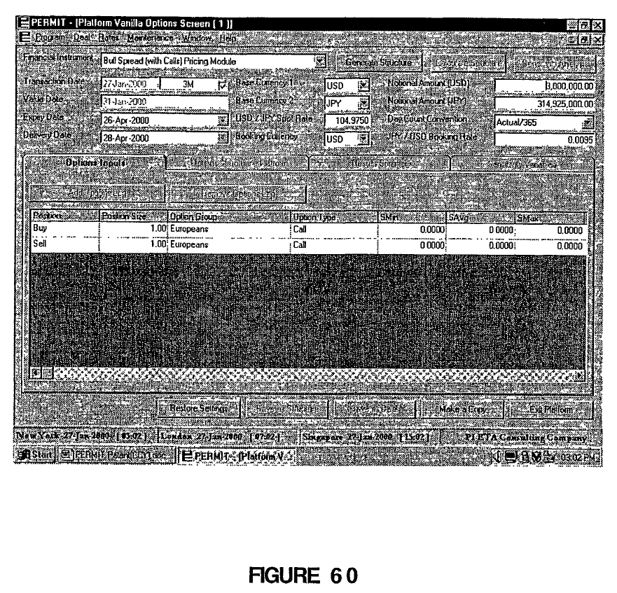

Next, the user then enters “3M” in the Tenor Box to indicate that the Option Structure is of a 3-month tenor (see FIG. 60). RMS automatically fills in the corresponding Expiry and Delivery Dates (these dates can be overwritten by the user if need be, i.e., RMS allows its user the flexibility to choose unconventional dates). The user now chooses USD as Base Currency 1 and JPY as Base Currency 2 from the respective Drop-down Lists. The Booking Currency is chosen to be USD by the user as a preference. Following this, the user enters 3,000,000 as the Notional Amount (USD) to start with. RMS automatically calculates the JPY equivalent amount (using the Spot Rate Input) and displays this amount as Notional Amount (JPY). DayCount Convention is defaulted by RMS to “Act/365”—the usual market convention for JPY. The user is of course free to choose a different setting for DayCount Convention.

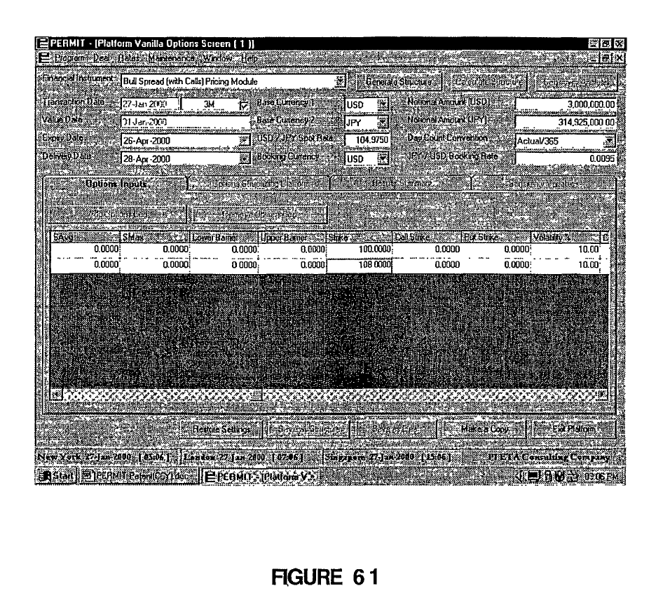

Moving down the Screen, the user then provides inputs that have not been “frozen out” or pre-selected. For example, the user has to provide the inputs for Strikes and Volatility (see FIG. 61).

Note that only the “Generate Structure” button at the top right-hand side of the screen is active. The other two buttons on the right are de-activated. Also, notice that the Option Structuring Platform Tab-sheet is “frozen” as the inputs on this Tab-sheet is only required at the second phase of the pricing process. This is done to ensure that the processing is carried out through a logical “flowchart” input and output system. At the bottom of the screen, the “Save as Structure” and “Save as Deal” buttons are inactive at this stage. The user is not allowed to save the settings as either a structure or a deal since the whole pricing and structuring process has not been completed at this stage. The other buttons are active as they do not affect the process.

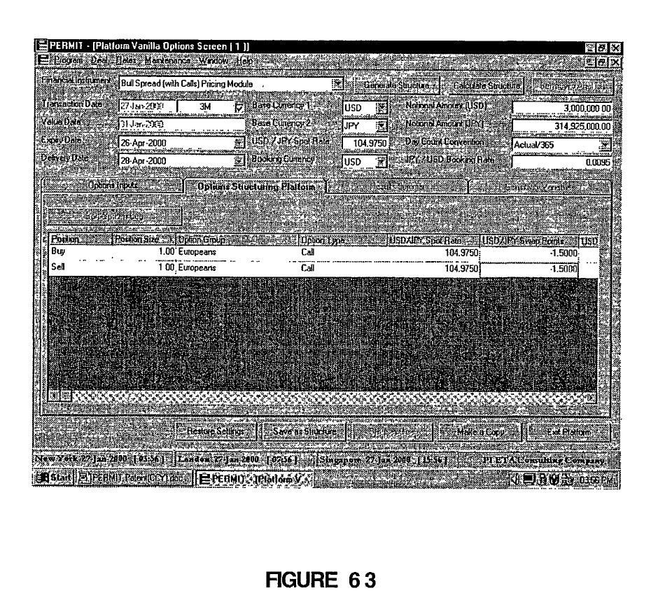

When the primary inputs have been completed, and the “Generate Structure” button is clicked once, the program takes the user to the secondary inputs (see FIG. 62). Notice that since the structure is a standard Bull Spread, no additional inputs are necessary. Also, notice that RMS has automatically filled in the USD/JPY Swap Points field (that appears on the Options Structuring Platform Tab-sheet) for the user. The user checks the auto-input, and feels that the market has moved significantly say, so provides an update to this input as a next step (see FIG. 63).

Note that the “Calculate Structure” button at the top right hand-side of the screen is now also active. The third button remains inactive. Notice that the Tab-sheet, Options Structuring Platform, is now open to the user as the inputs on these Tab-sheets are required at the second phase. In order to minimize user Input errors, RMS highlights the required additional inputs, and freezes out all other non-required inputs.

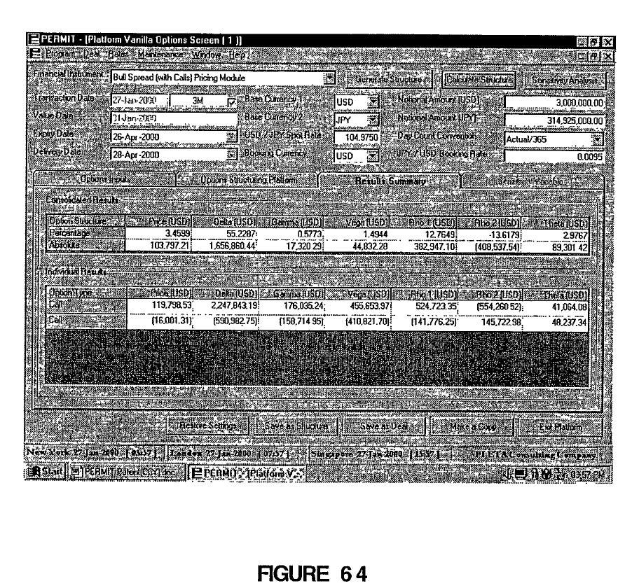

Once ALL the required additional inputs have been entered, the user then clicks on the “Calculated Structure” button. RMS continues with the process and provides the user with the outputs that appear on the “Results Summary” Tab-sheet (see FIG. 64). In this example, the numbers show that the Absolute Price of the Option structure sets the user back by around USD 104,000. This is known as the premium of the option structure.

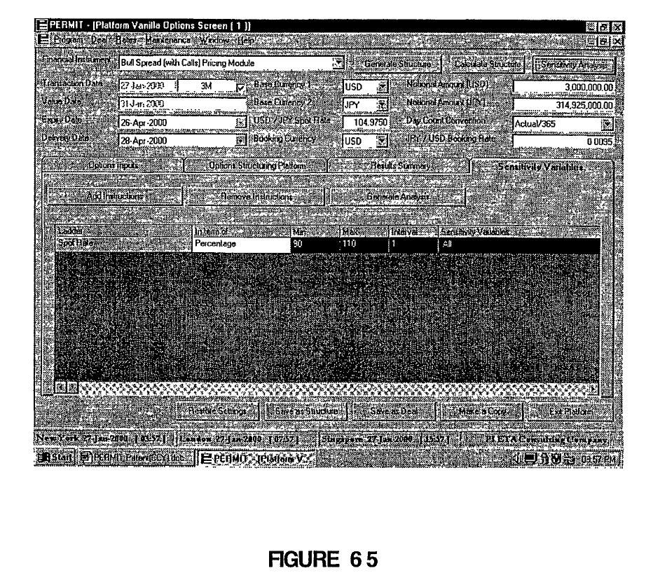

Note that at the top right-hand-side of the screen, the “Sensitivity Analysis” button is now finally active. Clicking on this button takes the user to a Sensitivity Variables Tab-sheet (see FIG. 65) that displays sensitivity analysis instructions from the user regarding the type of sensitivity analysis required for the current structure. At this stage, the structure Is now fully described and if it had been dealt, the user can now have the option of saving the structure as a deal by clicking on the now activated “Save as Deal” button at the bottom of the screen.

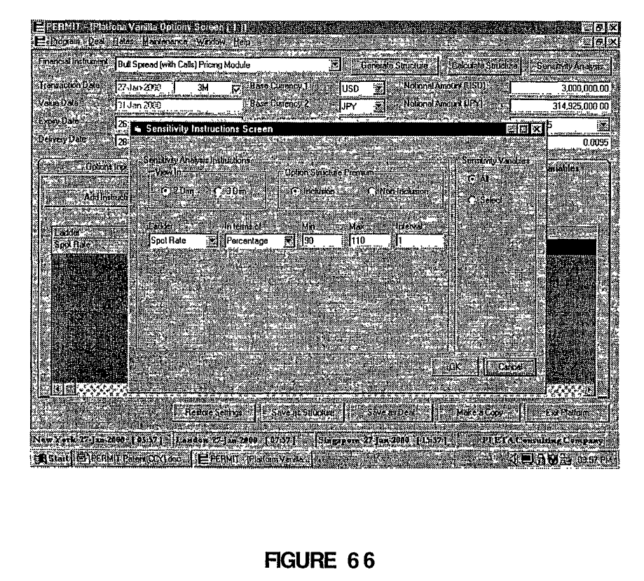

Suppose the user wishes to perform some form of sensitivity analysis—he wishes to see the effect of spot movements on the absolute price and the other sensitivity variables. He double-clicks on the first instruction line that appears on the Sensitivity Variables Tab-sheet, and out pops a “Sensitivity Instructions” Screen (see FIG. 66). Alternatively, he can also choose to click on the “Add Instructions” button on the same Tab-sheet. The user's requirements are keyed in at this stage, after which he clicks on the “OK” button.

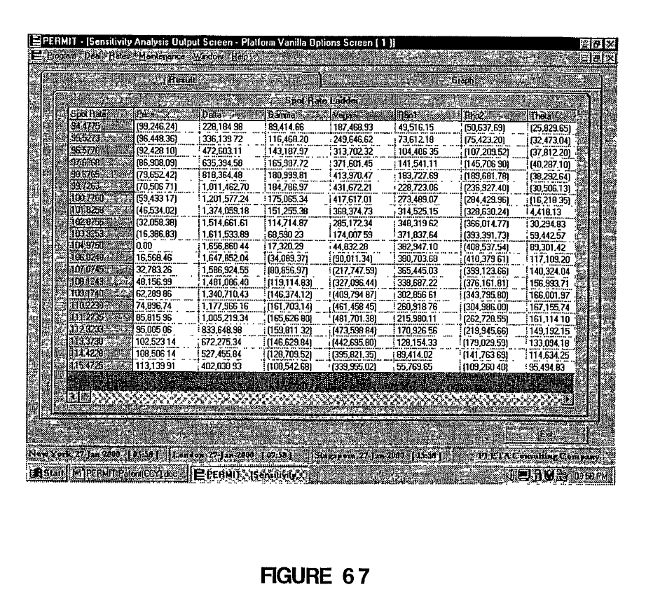

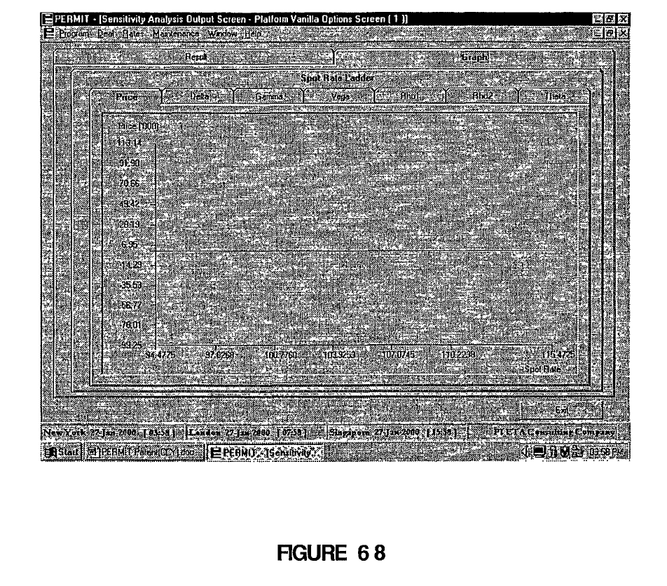

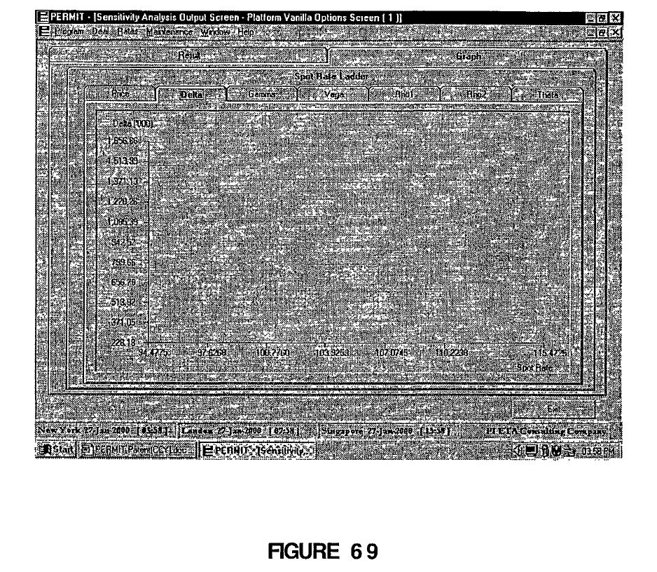

To continue with the processing, the user clicks on the “Generate Analysis” button on the Sensitivity Variables Tab-sheet. RMS carries out the required instructions and generates the desired sensitivity analysis results (see FIG. 67). If the user wishes to view graphical representations instead, he can choose the “Graph” Tab-sheet on the Sensitivity Analysis Output Screen, and the graphs will be displayed (see FIGS. 68 and 69)

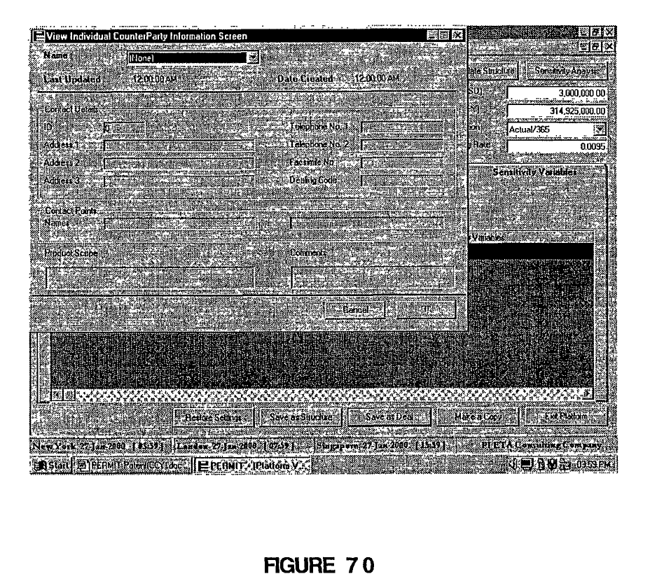

As part of the intelligent interfaces adopted by RMS, if the user should choose to save the structure as a Deal done, RMS will require further information about the Option Counter-party before allowing the details to be stored as a Deal in the database. At this point, RMS will prompt the user with a pop-up—“View Individual CounterParty Information” Screen (see FIG. 70).

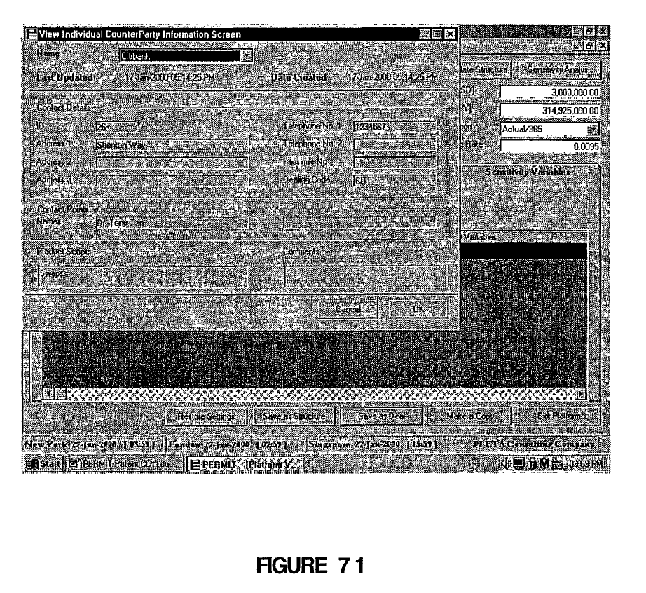

The user can choose the counterparty from the Drop-down list of existing active counterparties. Once the counterparty is chosen, RMS auto-fills the various fields relating to Counterparty Details information (see FIG. 71), and the deal can now be saved by clicking on the “OK” button.

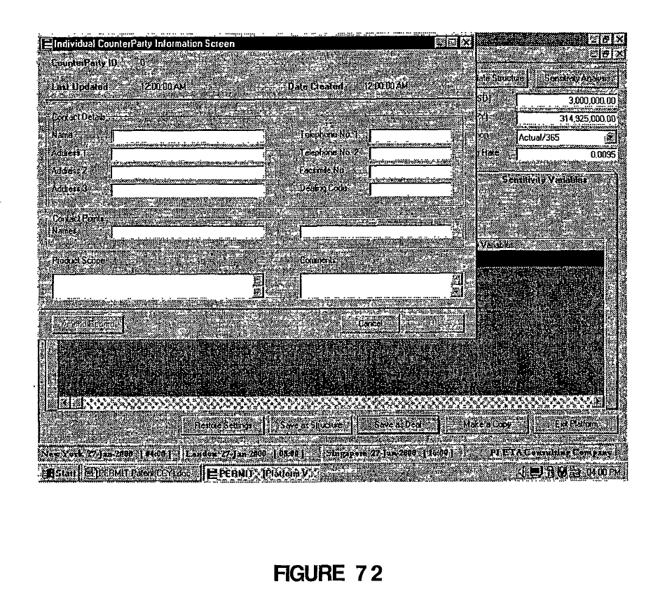

If the Counterparty Name is not on the Drop-down list of existing active counterparties, the user should choose the New Counterparty option and a new pop-up screen will appear for the user to input the details of the new counterparty (see FIG. 72).

Once the Counterparty information has been entered into RMS, all information about the deal is complete. The structure can now be saved as a Done Deal and ALL the information provided will be stored as a Deal in the database. RMS then automatically prints a hard copy of the Deal Report containing ALL the deal details.

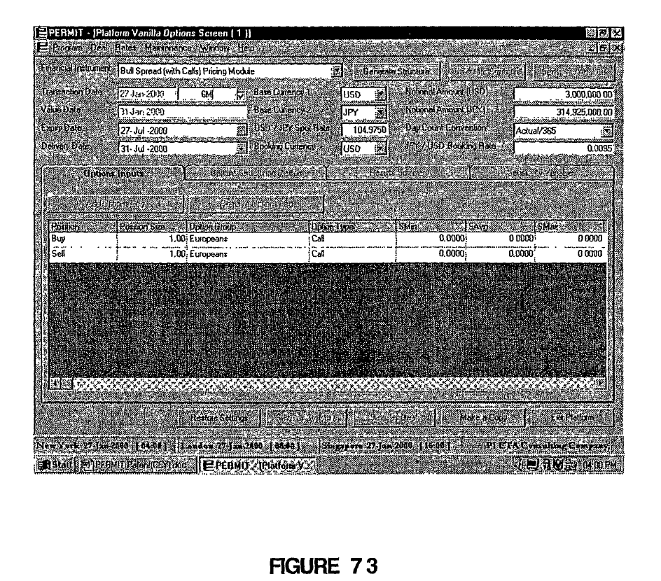

As a “safety” feature and to prevent possible mix-ups and errors, if for some reason the user changes any Phase 1 Inputs at any stage of the pricing and structuring process, RMS automatically returns the user to the primary input level, freezing all buttons and tab-sheets pertaining to other input phases. To illustrate, suppose the user in the previous example changes the Tenor from “3M” to “6M”. When this happens, RMS immediately returns the user to the Phase 1 Input Level (see FIG. 73). The user will then be required to go through all the different phases of inputs to structure and price the resulting new product.

Exotic Financial Instruments

Most financial derivatives and options pricing/structuring systems currently available in the market only allow users to price and structure financial instruments that are commonplace in the financial markets. RMS on the other hand has not been bound by current market instrument specifications or conventions, and has decidedly incorporated extended features that would enable users to price and structure fully flexible forward rate agreements, interest rate and cross currency swaps, caps, floors, digitals and/or combinations of any of the above as well as user-defined cashflows even before these instruments become available and commonplace in the financial markets.

The following are some of the extended instruments for which RMS can support:

Forward Rate Agreements.

An FRA (Forward Rate Agreement) is a financial agreement between two parties, involving forward interest rates. The parties involved agree on a LIBOR Currency Base (Underlying) interest rate level for a specified period of time in the future, applied to an agreed principal amount (in Base Currency Terms).

Interest Rate Swaps

Interest Rate Swaps (IRS) are swap transactions involving only interest rate cashflows. No principal cashflows are involved. In an Interest Rate Swap, the Base Currencies of both legs of the Swap are the same. In most IRS structures, for the leg that has Interest Mode set to Floating or Reverse Floating, the LIBOR Currency Base is the same as the Base Currency.

Cross Currency Swaps

Cross Currency Swaps (CCS) are swap transactions involving both interest rate and principal cashflows. In a Cross Currency Swap, the Base Currencies of the two legs of the Swap are always different, and for each leg of the Swap (that has Interest Mode set to Floating or Reverse Floating), the LIBOR Currency Base is usually the same as the Base Currency for that Swap Leg.

Interest Rate Caps

An Interest Rate Cap is a financial agreement between a writer (seller) of the cap and a borrower (buyer of the cap) to fully protect the borrower's floating interest rate payments at a specified level (the strike) for an agreed period of time. The agreement will include a reference to the interest cashflow Frequency, the LIBOR Base Currency (i.e., whether it is USD LIBOR, or JPY LIBOR etc.), the LIBOR Setting Basis (i.e., whether it is a 3-month LIBOR, or a 6-month LIBOR reference), the level of protection desired (strike level) and several other references which help to describe the Cap transaction fully.

Interest Rate Floors

An Interest Rate Floor is a financial agreement between a writer (seller) of the floor and a lender (buyer of the floor) to fully protect the lender's floating interest rate receipts at a specified level (the strike) for an agreed period of time. The agreement will include a reference to the interest cashflow Frequency, the LIBOR Base Currency (i.e., whether it is USD LIBOR, or JPY LIBOR etc.), the LIBOR Setting Basis (i.e., whether it is a 3-month LIBOR, or a 6-month LIBOR reference), the level of protection desired (strike level) and several other references which help to describe the Floor transaction fully.

Interest Rate Digital Caps

An Interest Rate Digital Cap is a financial agreement between a writer (seller) of the digital cap and a borrower (buyer of the digital cap) to partially protect the borrower's floating interest rate payments by compensating the borrower with a fixed interest payout if the floating interest rate rises above a specified level (the strike) at specified times for an agreed period of time. The agreement will include a reference to the interest cashflow Frequency, the LIBOR Base Currency (i.e., whether it is USD LIBOR, or JPY LIBOR etc.), the LIBOR Setting Basis (i.e., whether it is a 3-month LIBOR, or a 6-month LIBOR reference), the level of protection desired (strike level), the desired fixed interest payout and several other references which help to describe the Digital Cap transaction fully.

Interest Rate Digital Floors

An Interest Rate Digital Floor is a financial agreement between a writer (seller of the digital floor) and a lender (buyer of the digital floor) to partially protect the lender's floating interest rate receipts by compensating the lender with a fixed interest payout if the floating interest rate drops below a specified level (the strike) at specified times for an agreed period of time. The agreement will include a reference to the interest cashflow Frequency, the LIBOR Base Currency (i.e., whether it is USD LIBOR, or JPY LIBOR etc.), the LIBOR Setting Basis (i.e., whether it is a 3-month LIBOR, or a 6-month LIBOR reference), the level of protection desired (strike level), the desired fixed interest payout and several other references which help to describe the Digital Floor transaction fully.

Interest Rate Collars

The buyer of an Interest Rate Collar is usually a borrower who enters into a financial agreement to simultaneously purchase an Interest Rate Cap (say, at strike K₁,) and sell an Interest Rate Floor (say, at strike K₂), whereby the strikes K₁ and K₂ are adjusted such that K,>K₂ and the structure is at zero cost. The seller of an Interest Rate Collar, on the other hand, will usually be a lender who enters into a financial agreement to simultaneously purchase an Interest Rate Floor (say, at strike K₁) and sell an Interest Rate Cap (say, at strike K₂), whereby the strikes K₁ and K₂ are adjusted such that K₁<K₂ and the structure is at zero cost. The Interest Rate Collar agreement will include a reference to the interest cashflow Frequency, the LIBOR Base Currency (i.e., whether it is USD LIBOR, or JPY LIBOR etc.), the LIBOR Setting Basis (i.e., whether it is a 3-month LIBOR, or a 6-month LIBOR reference), the protection band desired (cap and floor strike levels) and several other references which help to describe the Collar transaction fully.

Interest Rate Digital Collars

The buyer of an Interest Rate Digital Collar is usually a borrower who enters into a financial agreement to simultaneously purchase an Interest Rate Digital Cap (say, with digital payout of P% and strike K₁) and sell an Interest Rate Digital Floor (say, with digital payout of P% and strike K₂), whereby the strikes K₁ and K₂ are adjusted such that K₁ >K₂ and the structure is at zero cost. The seller of an Interest Rate Digital Collar is usually a lender who enters into a financial agreement to simultaneously purchase an Interest Rate Digital Floor (say, with digital payout of P% and strike K₁,) and sell an Interest Rate Digital Cap (say, with digital payout of P% and strike K₂), whereby the strikes K, and K₂ are adjusted such that K₁<K₂ and the structure is at zero cost. In the above, it is possible for the digital payouts for the Interest Rate Digital Cap and the Interest Rate Digital Floor to be different. The Interest Rate Digital Collar agreement will include a reference to the interest cashflow Frequency, the LIBOR Base Currency (i.e., whether it is USD LIBOR, or JPY LIBOR etc.), the LIBOR Setting Basis (i.e., whether it is a 3-month LIBOR, or a 6-month LIBOR reference), the protection band desired (digital cap and digital floor strike levels), the desired digital payouts and several other references which help to describe the Digital Collar transaction fully.

### EXAMPLE 4

Suppose a user wishes to structure and price the following Exotic Interest Rate Swap using RMS.

Swap Details: Forward Start 1-year by 2-year Exotic U.S. Dollar (USD) Interest Rate Swap (IRS) whereby on a Bi-monthly basis, the user pays fixed USD interest at 5.05% p.a. and on a Quarterly basis, receives Reverse Floating USD interest based on the formula : 10.00% (“Reverse Floating Har”) minus 6-month EUR LIBOR benchmark rate. The Notional Amount of the IRS is set at USD 1 million for the whole tenor.

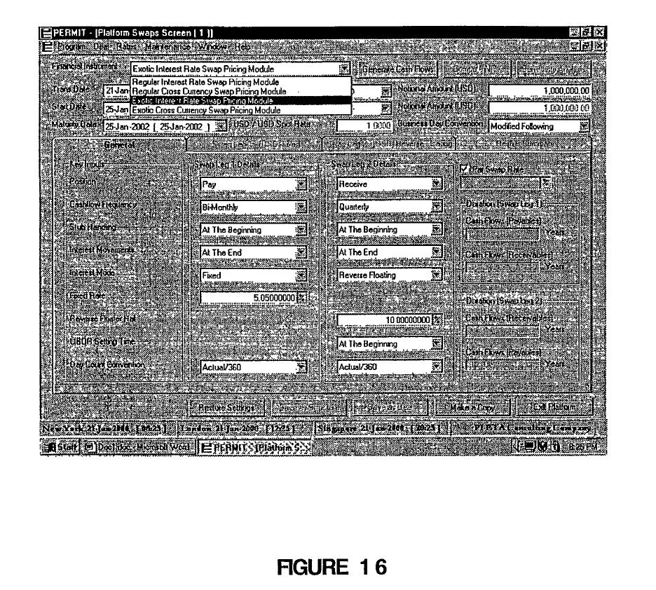

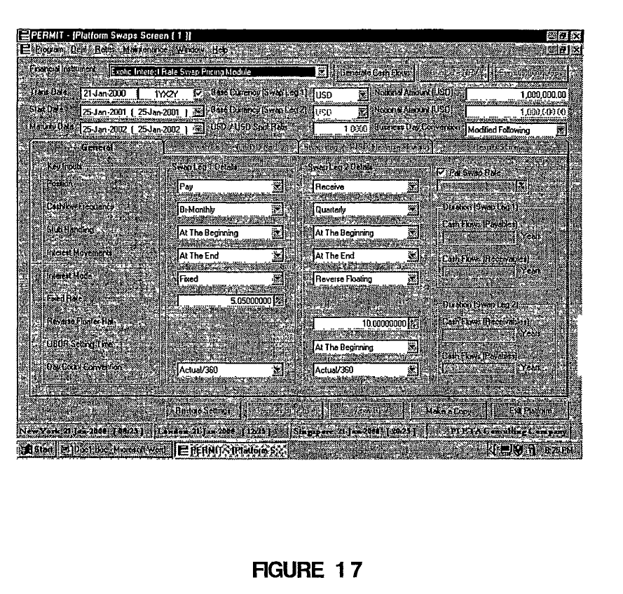

The user first chooses the Platform Swaps Module which takes the user to the Platform Swaps Screen. The user then has to select ”Exotic Interest Rate Swap Pricing Module” from the Financial Instrument Drop-down List (see FIG. 16). Once this is selected, RMS automatically “forces” or pre-sets certain settings that pertain to exotic Interest Rate Swaps, thus facilitating the input process (see FIG. 17).

Next, the user then enters “lY X 3Y” in the Tenor Box to indicate that the forward start IRS is of a 1-year by 2-year tenor. RMS automatically fills in the corresponding Start and Maturity Dates (these dates can be overwritten by the user if need be, i.e., RMS allows its user the flexibility to choose unconventional dates). The user now chooses USD as the Base Currency (Swap Leg 1) from the Drop-down List. Notice that RMS automatically sets the Base Currency of Swap Leg 2 to USD since the financial Instrument chosen Is an IRS. Following this, the user enters 1,000,000 as the Notional Amount to start with. Business Day Convention is chosen to be “Modified Following”—the usual market convention to adopt for such Swaps. Moving down the Screen, the user then provides inputs that have not been “frozen out” or pre-selected.

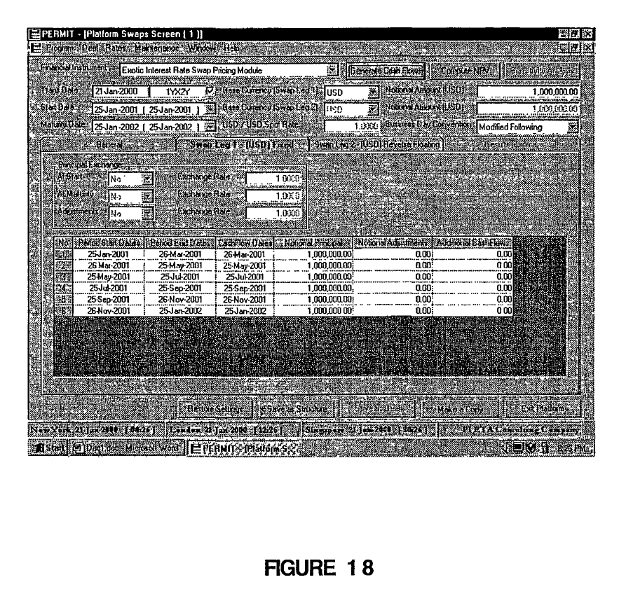

When the primary inputs have been entered, and the “Generate Cash Flows” button is clicked once, the program takes the user to the secondary inputs (see FIG. 18). Notice that since the structure is an IRS, no principal exchanges are necessary, hence as part of the input pre-selection process, Principal Exchanges at Start, at Maturity and Adjustments have been set to “NO”.

Note that the “Compute NPV” button at the top right hand-side of the screen is now also active. The third button remains inactive. Notice that the Tab—sheets, Swap Leg 1—(USD) Fixed and the Swap Leg 2—(USD) Reverse Floating, are now open to the user as the inputs on these Tab—sheets may be required at the secondary inputs. In order to minimize user input errors, RMS pre-sets the parameters in the Principal Exchange Box.

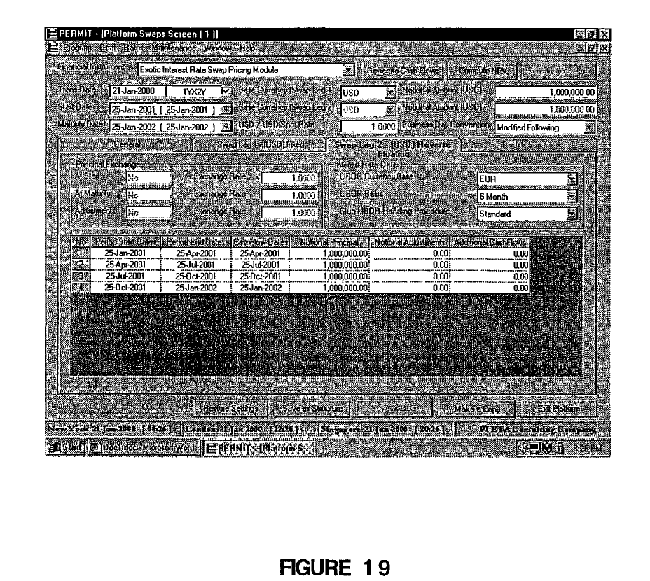

Referring to FIG. 18, RMS has automatically generated the relevant Period Start and End Dates, together with the corresponding cashflow dates (see first three columns of Tab-sheet Swap Leg 1—(USD) Fixed). Also notice that the Notional Amounts are all set at 1,000,000. As our desired structure does not require any adjustments to the Notional Amounts, we may proceed to the Swap Leg 2—(USD) Reverse Floating Tab-sheet (see FIG. 19).

Our “Exotic” structure requires that we set the LIBOR Currency Base to EUR and the LIBOR Basis to 6-Month for Swap Leg 2 (see Swap Leg 2—(USD) Reverse Floating Tab-sheet in FIG. 19).

Note from FIG. 18 that since Leg 1 of the Swap is of a Fixed Interest Rate nature, i.e., the Interest is already fully determinable without further input, the “Interest Rate Details” input box does not appear on the Swap Leg 1—(USD) Fixed Tab-sheet. On the other hand, as Leg 2 of the Swap is of a Reverse Floating Interest Rate nature, further inputs are required, RMS prompts this by showing the “Interest Rate Details” input box on the Swap Leg 1—(USD) Reverse Floating Tab-sheet (compare FIGS. 18 and 19 If this were a Regular Interest Rate Swap, the required inputs for an IRS would have been pre-set, but since this is an Exotic Interest Rate Swap, the required inputs have not been pre-set and the user is required to provide these inputs.

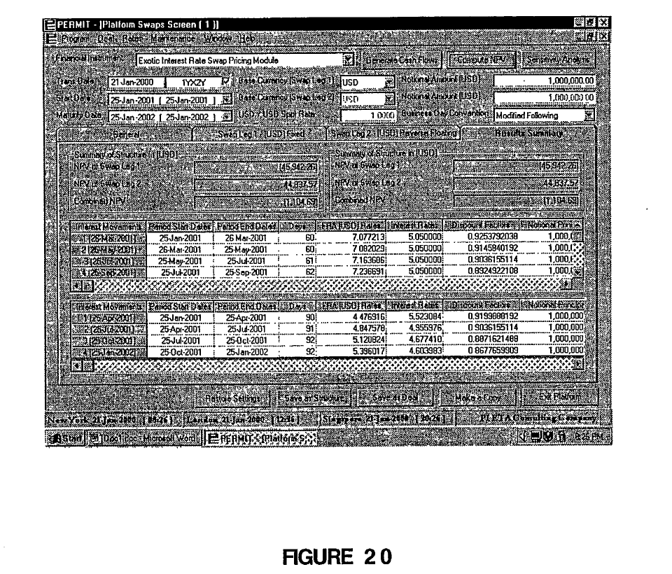

Once all the required inputs have been entered, the user then clicks on the “Compute NPV” button. RMS continues with the process and provides the user with the outputs that appear on the “Results Summary” Tab-sheet (see FIG. 20). In this example, the numbers show that the Combined NPV of the Swap structure sets the user back by around USD 1,100. This is sometimes known as the “transaction cost” of the swap, or from the bankers' perspective, the spread income. Note that at the top right-hand-side of the screen, the “Sensitivity Analysis” button is now finally active. Clicking on this button takes the user to a Sensitivity Analysis Screen (see FIG. 21) that displays certain sensitivity analysis results indicating to the user how changes in the Yield Curve will affect the pricing of this structure. At this stage, the structure is now fully described and if it had been dealt, the user can now have the option of saving the structure as a deal by clicking on the now activated “Save as Deal” button at the bottom of the screen. In this example, the user chooses not to save the structure at all, and hence he can proceed to exit the Platform directly.

### EXAMPLE 5

Suppose a user wishes to structure and price the following Exotic Cross Currency Swap using RMS.

Swap Details: 2-year Exotic Great Britain Pound (GBP)/Japanese Yen (JPY) Cross

Currency Swap (CCS) whereby on a quarterly basis, the user pays floating GBP interest

based on the 3-month USD LIBOR benchmark rate and receives floating JPY interest based

on the 1-month SGD LIBOR benchmark rate. The Notional Amount of the CCS is set at GBP

10 million for the whole tenor of the swap.

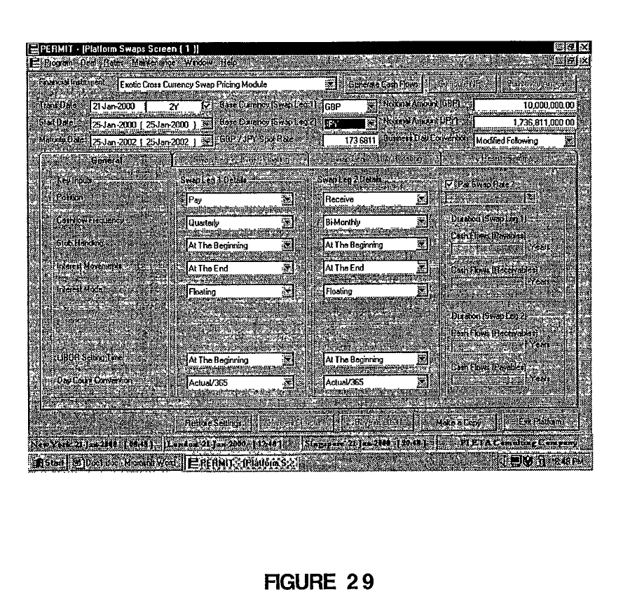

The user first chooses the Platform Swaps Module which takes the user to the Platform Swaps Screen. The user then has to select “Exotic Cross Currency Swap Pricing Module” from the Financial Instrument Drop-down List (see FIG. 29).

Next, the user then enters “2Y” in the Tenor Box to indicate that the CCS is of a 2-year tenor. RMS automatically fills in the corresponding Start and Maturity Dates (these dates can be overwritten by the user if need be, i.e., RMS allows its user the flexibility to choose unconventional dates). The user now chooses GBP as the Base Currency (Swap Leg 1) and JPY as the Base Currency (Swap Leg 2) from the respective Drop-down Lists. Notice that RMS does not automatically set the Base Currency of Swap Leg 2 o GBP and that the input field is not “frozen” since the instrument chosen is a CCS. Following this, the user enters 10,000,000 as the Notional Amount to start with. Business Day

Convention is chosen to be “Modified Following”—the usual market convention to adopt for such Swaps. Moving down the Screen, the user then provides the other required inputs.

At this point, only the “Generate Cash Flows” button at the top right-hand side of the screen is active. The other two buttons on the right are de-activated. Also, notice that the Swap Leg 1—(GBP) Floating and the Swap Leg 2—(JPY) Floating Tab-sheets are “frozen” as the inputs on these Tab-sheets are only required at the second phase of the pricing process. This is done to ensure that the processing is carried out through a logical “flowchart input and output system.

At the bottom of the screen, the “Save as Structure” and “Save as Deal” buttons are inactive at this stage. The user is not allowed to save the settings as either a structure or a deal since the whole pricing and structuring process has not been completed at this stage. The other buttons are active as they do not affect the process.

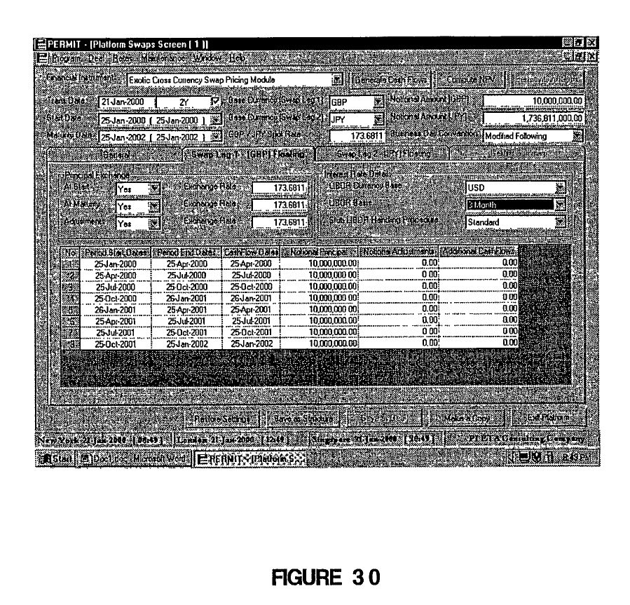

When the primary inputs have been completed, and the “Generate Cash Flows” button is clicked once, the program takes the user to the secondary inputs (see FIG. 30). Notice that since the structure is a CCS, principal exchanges may be necessary, hence as part of the input pre-selection process, Principal Exchanges at Start, at Maturity and Adjustments have been defaulted to “YES”, and can be changed by the user to “NO”.

Note that the “Compute NPV” button at the top right hand-side of the screen is now also active. The third button remains inactive. Notice that the Tab-sheets, Swap Leg 1—(GBP) Floating and the Swap Leg 2—(JPY) Floating, are now open to the user as the inputs on these Tab-sheets may be required at the second phase. In order to minimize user input errors, RMS defaults the parameters in the Principal Exchange Box.

Referring to FIG. 30, RMS has automatically generated the relevant Period Start and End Dates, together with the corresponding cashflow dates (see first three columns of Tab-sheet Swap Leg 1—(GBP) Floating). Notice that the Notional Amounts are all set at 10,000,000. Since our desired structure is such that the Notional Amount is to remain at 10,000,000 for the whole tenor of the swap, no Notional Adjustments are required.

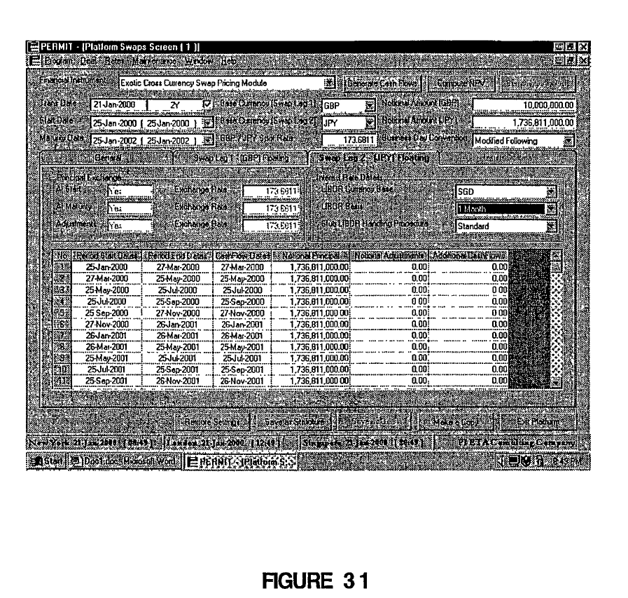

Our “Exotic” structure requires that we set the LIBOR Currency Base to USD and the LIBOR Basis to 3-Month for Swap Leg 1 (see Swap Leg 1—(GBP) Floating Tab-sheet in FIG. 30) and the LIBOR Currency Base to SGD and the LIBOR Basis to 1-Month for Swap Leg 2 (see Swap Leg 2—(JPY) Floating Tab-sheet in FIG. 31).

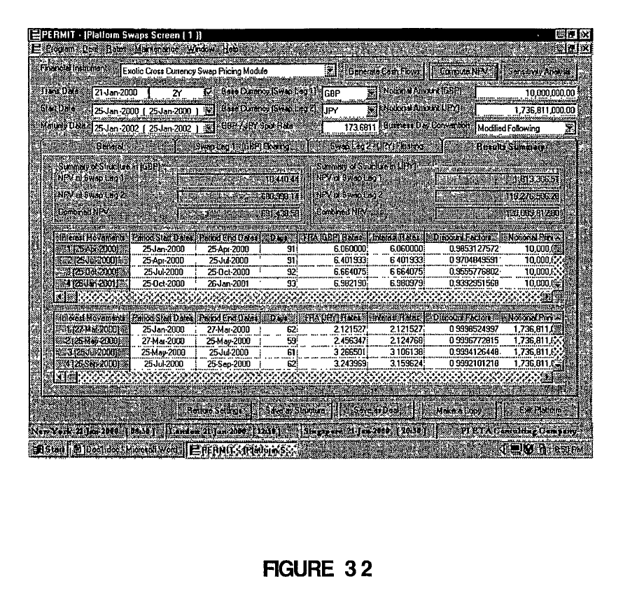

Once ALL the required inputs have been entered, the user then clicks on the “Compute NPV” button. RMS continues with the process and provides the user with the outputs that appear on the “Results Summary” Tab-sheet (see FIG. 32). In this example, the numbers show that the Combined NPV of the Swap structure sets the user back by around GBP 700,000. This is sometimes known as the “transaction cost” of the swap, or from the bankers' perspective, the spread income.

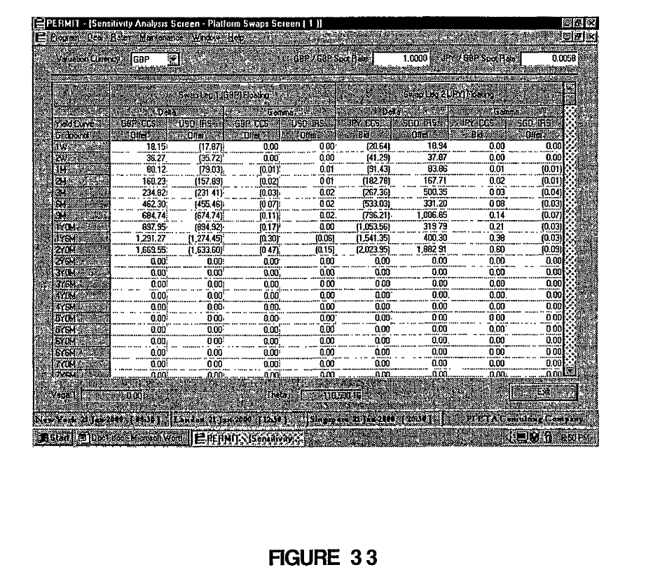

Note that at the top right-hand-side of the screen, the “Sensitivity Analysis” button is now finally active. Clicking on this button takes the user to a Sensitivity Analysis Screen (see FIG. 33) that displays certain sensitivity analysis results indicating to the user how changes in the Yield Curve will affect the pricing of this structure.

At this stage, the structure is now fully described and if it had been dealt, the user can now have the option of saving the structure as a deal by clicking on the now activated “Save as Deal” button at the bottom of the screen.

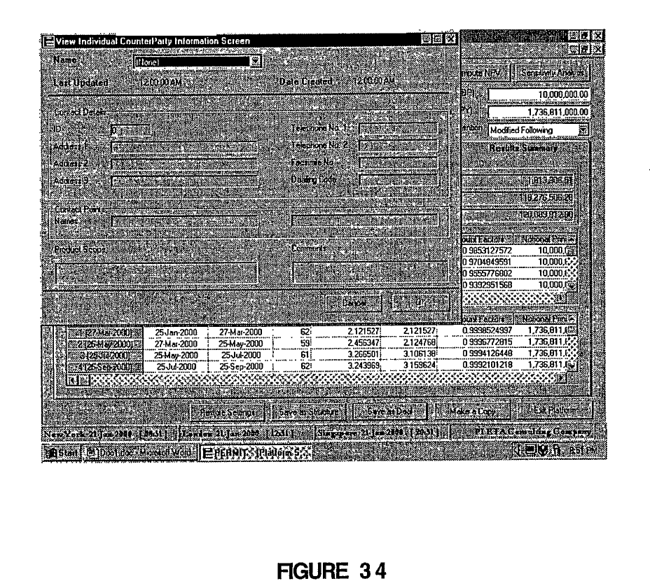

If the user should choose to save the structure as a Deal done, RMS will require further information about the Swap Counter-party before allowing the details to be stored as a Deal in the database. At this point, RMS will prompt the user with a pop-up—“View Individual CounterParty Information” Screen (see FIG. 34).

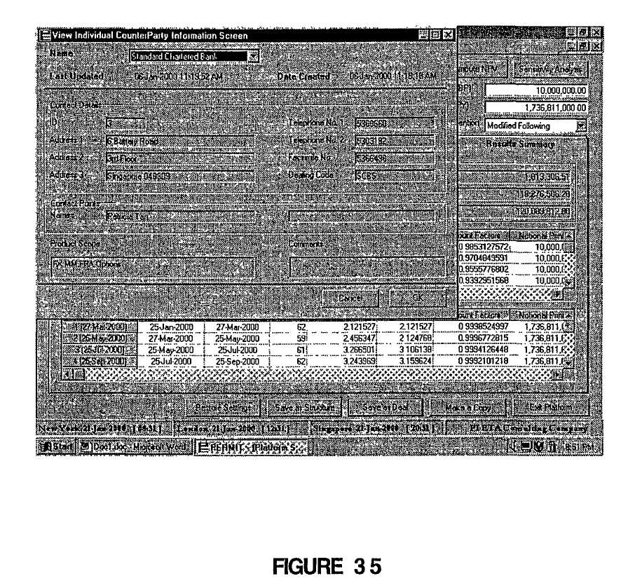

The user can choose the counterparty from the Drop-down list of existing active counterparties. Once the counterparty is chosen, RMS auto-fills the various fields relating to Counterparty Details information (see FIG. 35), and the deal can now be saved by clicking on the “OK” button.

If the Counterparty Name Is not on the Drop-down list of existing active counterparties, the user should choose the New Counterparty option and a new pop-up screen will appear for the user to input the details of the new counterparty.

Once the Counterparty information has been entered into RMS, all information about the deal is complete. The structure can now be saved as a Done Deal and ALL the information provided will be stored as a Deal in the database. RMS then automatically prints a hard copy of the Deal Report containing ALL the deal details.

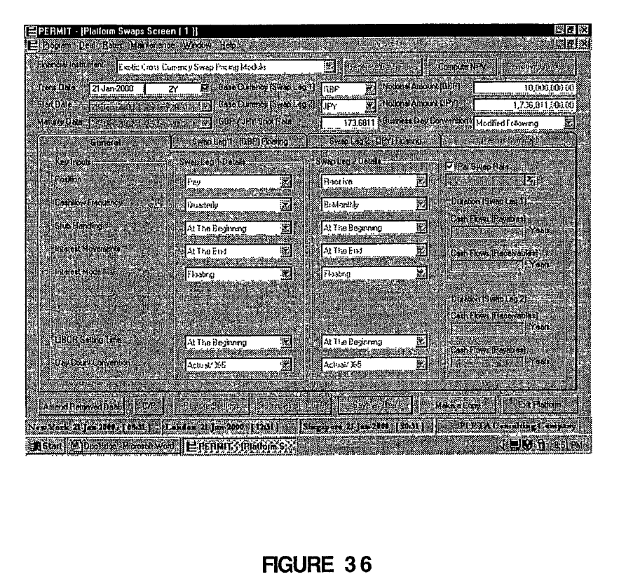

As a security feature, once a Deal has been saved, RMS immediately “freezes” all the input fields of the Deal (see FIG. 36). This is to prevent unauthorized manipulation of deals. Only a manager or an authorized personnel can make amendments to deal inputs. To make such amendments, they should click on the “Amend Retrieved Deal” button at the bottom left-hand side of the screen and provide the correct password. Once RMS has verified the password, the deal Inputs become “unfrozen” and amendments to deal inputs can now be made.

### EXAMPLE 6

Platform (FRAs) allows the user to price Exotic Forward Rate Agreements (FRAs) whereby the Interest Mode can be set to “Reverse Floating”. This revolutionary idea of allowing “Reverse Floating” FRAs is new as most FRAs in the market have their interest amounts calculated based only on a regular floating basis. The term “Reverse Floater Hat”, used in conjunction with the “Reverse Floating” notion in a Swap, is also a new concept.

For example, RMS has the ability to price a 3-month by 6-month Exotic Forward Rate Agreement whereby a user chooses to pay USD Interest for the period starting 3months from now and ending 6months from now based on the formula: 10.00% (“Reverse Floater Hat”) minus the 3-month USD LIBOR benchmark, and to receive USD interest for the same period based on a fixed rate of 3.80% p.a. say.

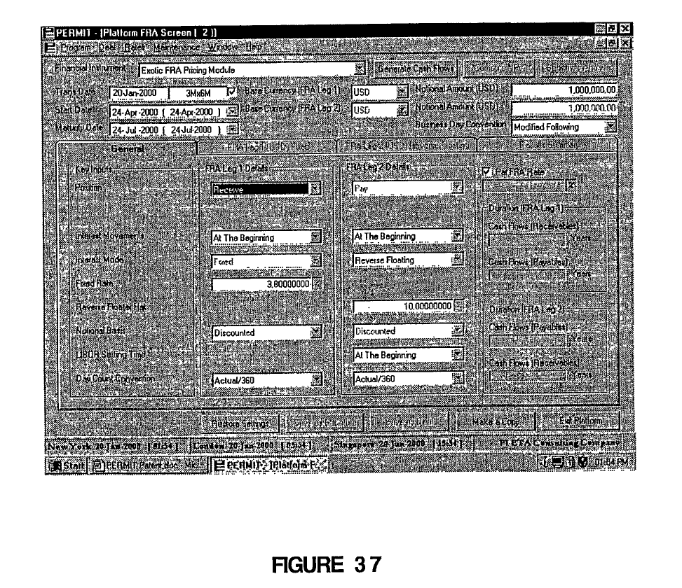

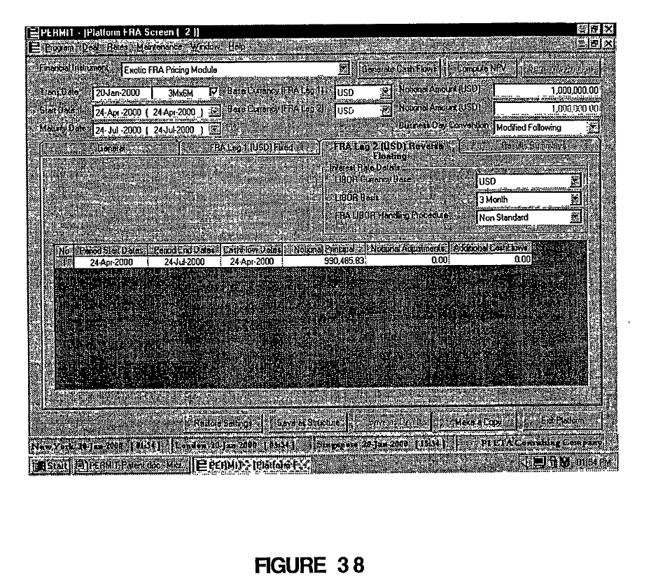

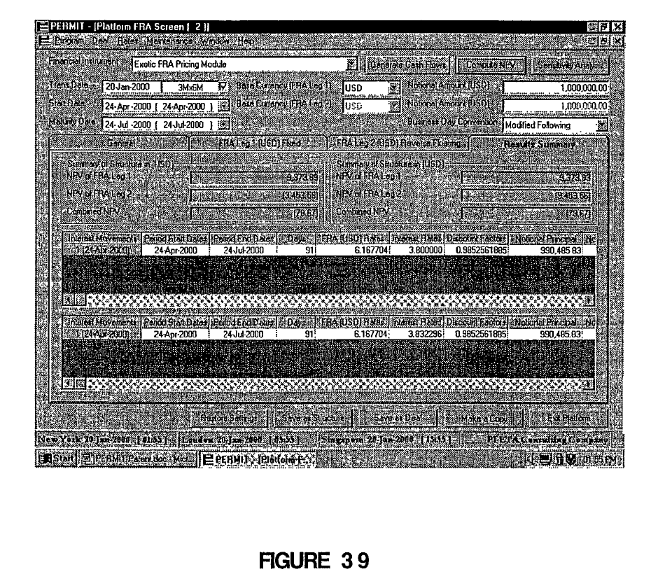

FIG. 37 shows the interface for entering the primary inputs for this example. FIG. 38 shows the interface for entering the secondary inputs for this example. FIG. 39 shows the interface displaying the structure calculation results.

### EXAMPLE 7

Platform (FRAs) allows the user to price Exotic Forward Rate Agreements whereby the LIBOR Currency Base is of a different currency from the Base Currency for the FRA. In addition to the above, Platform (FRAs) also allows the user to choose an FRA Tenor that does not match the LIBOR Setting Basis.

For example, RMS has the ability to price a 3month by 6month Exotic Forward Rate Agreement whereby a user chooses to receive USD interest for the period starting 3 months from now and ending 6 months from now based on the 2-month SGD LIBOR benchmark, and to pay USD interest for the same period based on a fixed rate of 2.35% say.

The special feature described here can also be used in conjunction with the special feature described in paragraph 1 to construct an even more exotic FRA.

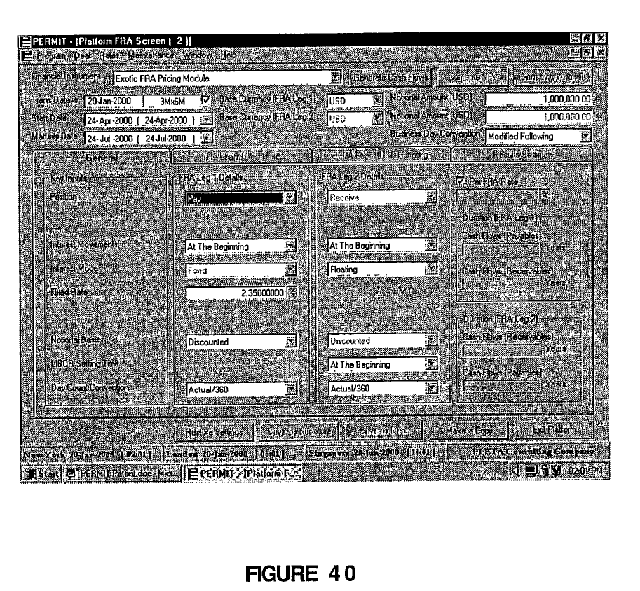

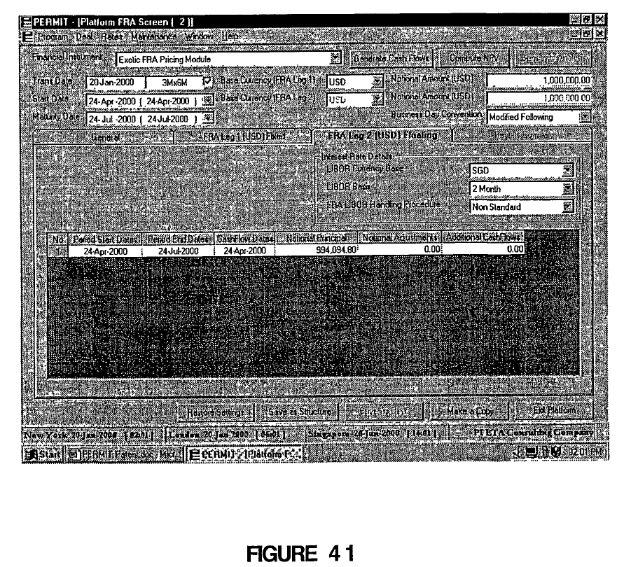

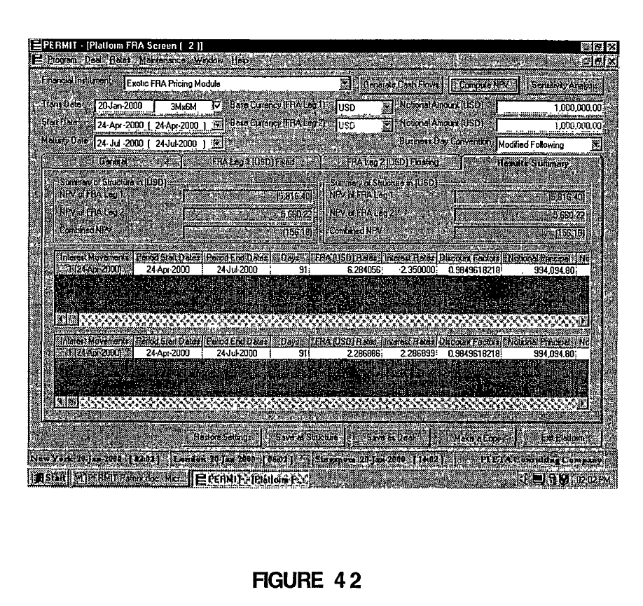

FIG. 40 shows the interface for entering the primary inputs for this example. FIG. 41 shows the interface for entering the secondary inputs for this example. FIG. 42 shows the interface displaying the structure calculation results.

### EXAMPLE 8

Platform (Swaps) allows the user to price Exotic Interest Rate and Cross Currency Swaps whereby the Interest Mode for a particular Swap Leg can be set to “Reverse Floating”. This idea of allowing “Reverse Floating” Swap Legs is new as most Swaps in the market have their interest amounts calculated based either on a fixed or regular floating basis. The term “Reverse Floater Hat”, used in conjunction with the “Reverse Floating” notion in a Swap, is also a new concept.

For example, RMS has the ability to price a 3-year Exotic Interest Rate Swap whereby a user chooses to receive USD interest every 6 months based on the formula: 10.00% (“Reverse Floater Hat”) minus the 6-month USD LIBOR benchmark, and to pay USD interest every 6 months based on a fixed rate of 3.05% p.a. say.

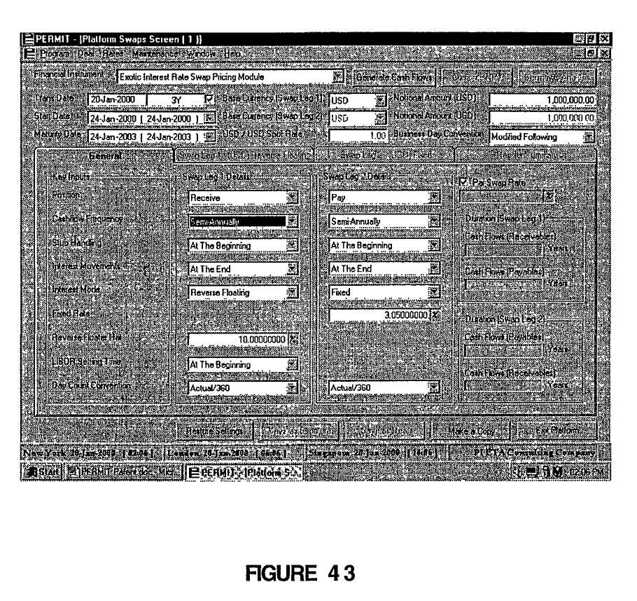

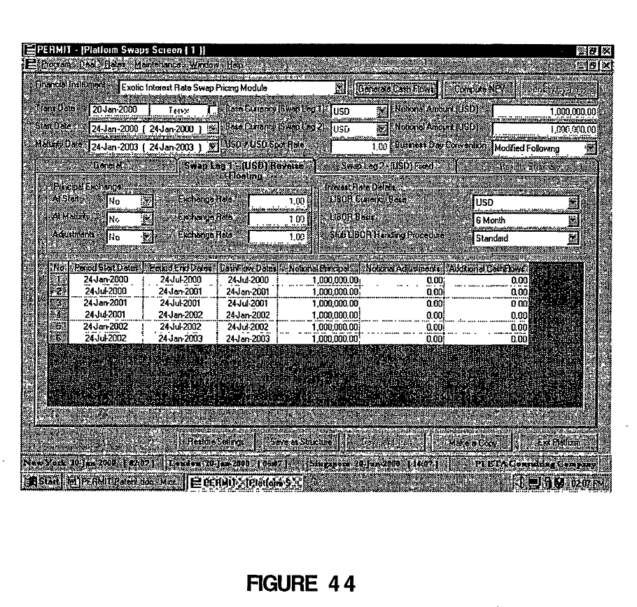

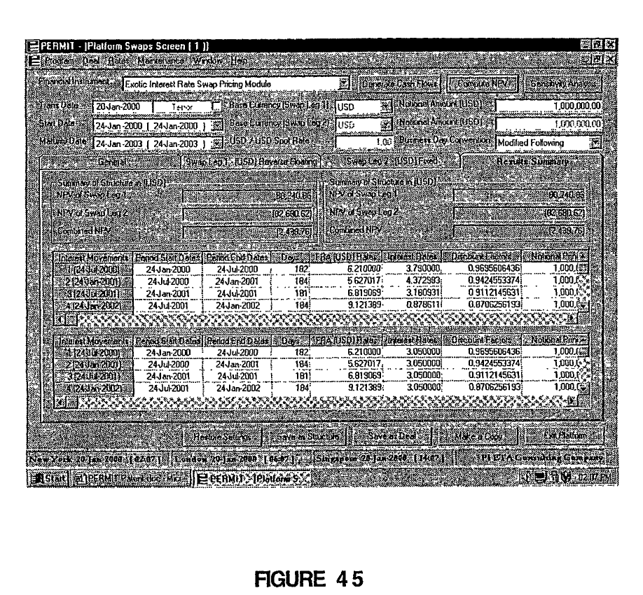

FIG. 43 shows the interface for entering the primary inputs for this example. FIG. 44 shows the interface for entering the secondary inputs for this example. FIG. 45 shows the interface displaying the structure calculation results.

### EXAMPLE 9

Platform (Swaps) allows the user to price Exotic Interest Rate and Cross Currency Swaps whereby the LIBOR Currency Base is of a different currency from the Base Currency for a particular Swap Leg. In addition to the above, Platform (Swaps) also allows the user to choose a Cashflow Frequency that does not match the LIBOR Setting Basis for each of the Swap Legs.

For example, RMS has the ability to price a 5-year Exotic Cross Currency Swap whereby a user chooses to receive USD interest every 6 months based on the 3-month JPY LIBOR benchmark, and to pay GBP interest every month based on the 3-month CHF LIBOR benchmark.

The special feature described here can also be used in conjunction with the special feature described In paragraph 3 to construct an even more exotic Swap.

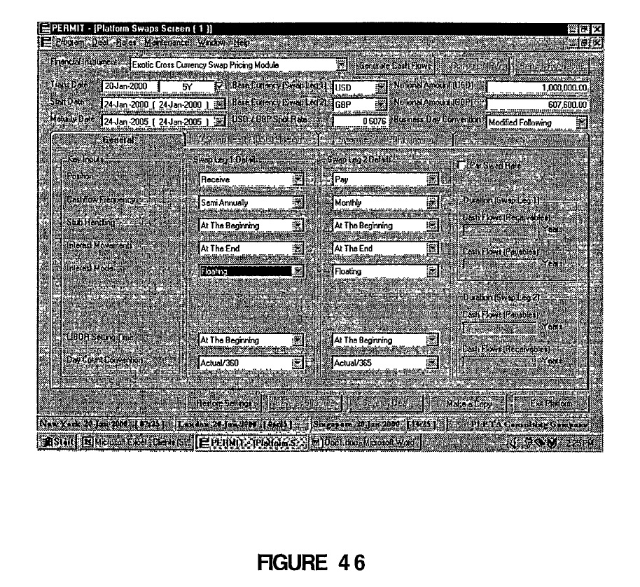

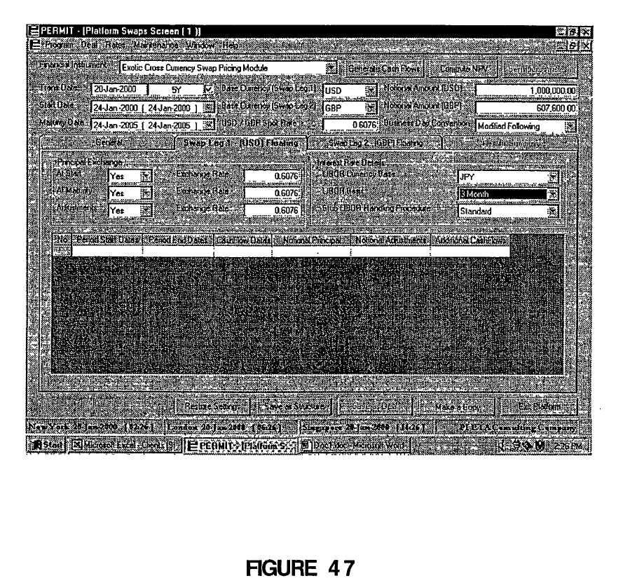

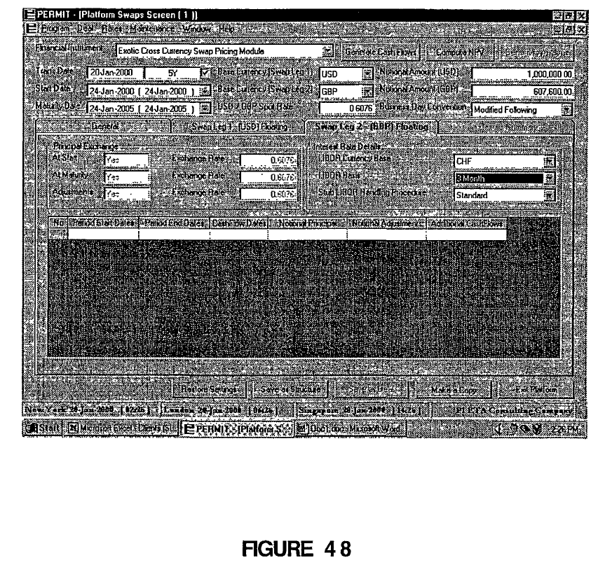

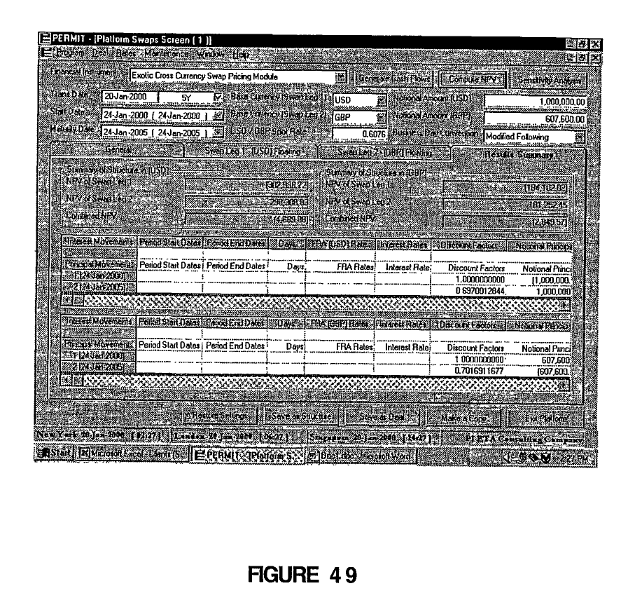

FIG. 46 shows the interface for entering the primary inputs for this example. FIG. 47 shows the interface for entering the secondary inputs for this example for Leg 1. FIG. 48 shows the interface for entering the secondary inputs for this example for Leg 2. FIG. 49 shows the interface displaying the structure calculation results.

### EXAMPLE 10

Platform (Caps/Floors/Digitals) allows the user to price Exotic Caps/Floors/Digitals and combinations thereof, whereby the LIBOR Currency Base is of a different currency from the Base Currency for a particular Cap/Floor/Digital Leg. In addition to the above, Platform (Caps/Floors/Digitals) also allows the user to select a Cashflow Frequency that does not match the LIBOR Setting Basis for the particular Cap/Floor/Digital Leg.

For example, RMS has the ability to price a 3-year Exotic Cap whereby a user receives USD interest every 6 months calculated based on the difference between the 3-month CHF LIBOR benchmark rate and 2.00% (Cap Strike Rate) if the 3-month CHF LIBOR benchmark rate is greater than 2.00%; else nothing.

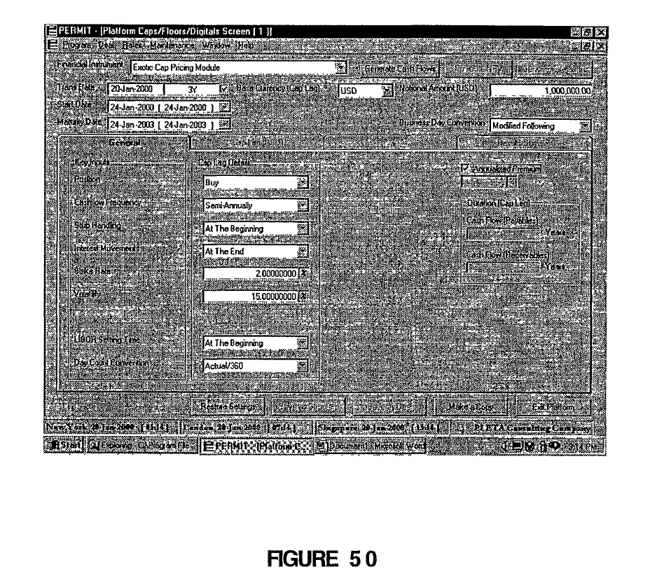

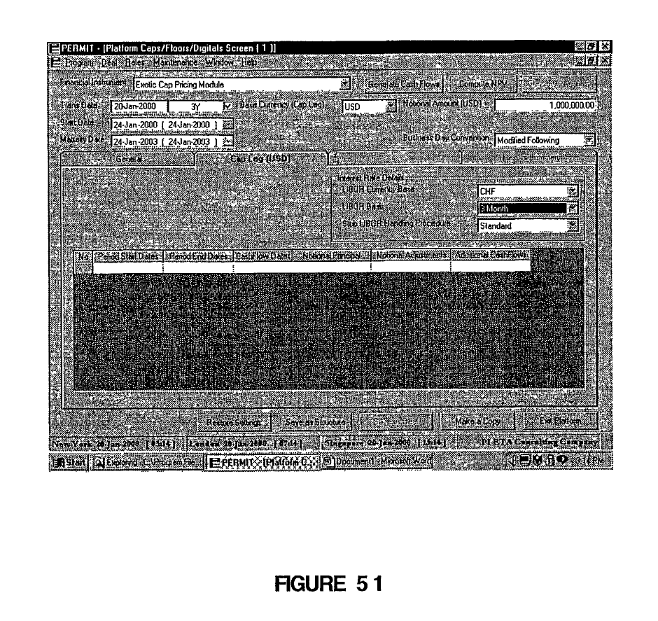

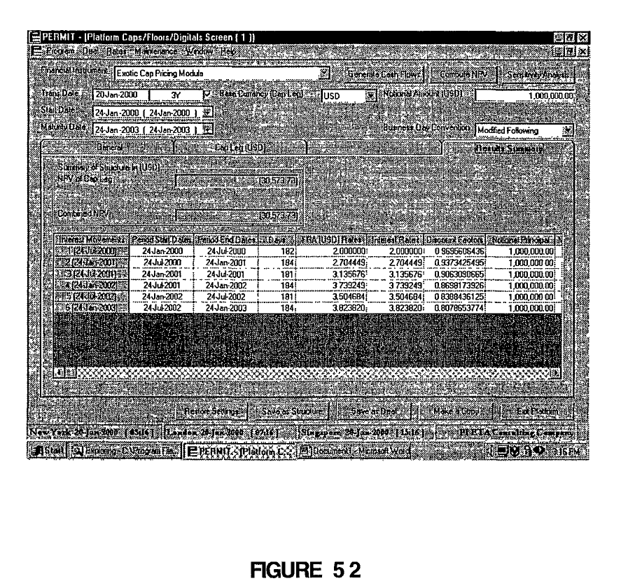

FIG. 50 shows the interface for entering the primary inputs for this example. FIG. 51 shows the interface for entering the secondary inputs for this example. FIG. 52 shows the interface displaying the structure calculation results.

Other Platforms

The process employed by the examples shown above maybe applied to other platforms. The tables shown below list the relevant features of each of the platforms and their corresponding financial instruments.

TABLE 1
Platform (FRAs)

| | |
|---|---|
| REGULAR FRA | This option allows the user to price only regular FRA structures. When this |
| Pricing Module | option is chosen, some of the inputs will automatically be pre-selected. |
| | The pre-selected inputs are: |
| | Interest Movements: At The Beginning. |
| | LIBOR Setting Time: At The Beginning. |
| | LIBOR Currency Base: Will be set to the Base Currency. |
| | FRA LIBOR Handling Procedure: Will be set to Standard. |
| | DayCount Convention: Will be set to the DayCount Convention of the |
| | underlying Base Currency. |
| | In addition to the above, FRA Leg 1 will have its Interest Mode set to Fixed |
| | and FRA Leg 2 will have its Interest Mode set to Floating. |
| | The pre-selected inputs cannot be changed by the user once the regular |
| | pricing module is chosen; to change any of these pre-selected inputs, the |
| | user should re-select the EXOTIC FRA Pricing Module. |
| EXOTIC FRA | This option allows the user the full flexibility to price variations of the regular |
| Pricing Module | structure. |
| | As in the Regular Module, FRA Leg 1 will have its Interest Mode set to Fixed. |
| | RMS allows the user to set the Interest Mode of FRA Leg 2 to either the |
| | Floating mode or the Reverse Floating Mode. |

TABLE 2
Platform (Swaps)

| | |
|---|---|
| REGULAR | This option allows the user to price only regular Interest Rate Swap |
| Interest Rate Swap | structures. When this option is chosen, some of the inputs will automatically |
| Pricing Module | be pre-selected. |
| | The pre-selected inputs are: |
| | Base Currency (Leg 2): Will be set to Base Currency (Leg 1) |
| | Notional Amount (Leg 2): Will be set to Notional Amount (Leg 1) |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | The pre-selected inputs cannot be changed by the user once this module is |
| | chosen; to change any of these pre-selected inputs, the user should re-select |
| | another Pricing Module. |
| REGULAR | This option allows the user to price only regular Cross Currency Swap |
| Cross Currency | structures. When this option is chosen, some of the inputs will automatically |
| Swap Pricing | be pre-selected. |
| Module | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | The pre-selected inputs cannot be changed by the user once this module is |
| | chosen; to change any of these pre-selected inputs, the user should re-select |
| | another Pricing Module. |
| EXOTIC | This option allows the user to price different forms of exotic Interest Rate |
| Interest Rate Swap | Swap structures. When this option is chosen, some of the inputs will |
| Pricing Module | automatically be pre-selected. |
| | The pre-selected inputs are: |
| | Base Currency (Leg 2): Will be set to Base Currency (Leg 1) |
| | Notional Amount (Leg 2): Will be set to Notional Amount (Leg 1) |
| | The pre-selected inputs cannot he changed by the user once this module is |
| | chosen; to change any of these pre-selected inputs, the user should re-select |
| | another Pricing Module. |
| EXOTIC | This option allows the user to price different forms of exotic Cross Currency |
| Cross Currency | Swap structures. When this option is chosen, none of the inputs will be pre- |
| Swap Pricing | selected. The user is free to specify the full structure of the exotic Cross |
| Module | Currency Swap. |

TABLE 3
Plafform (Caps/Floors/Digitals)

| | |
|---|---|
| REGULAR | This option allows the user to price only regular Cap structures. When this |
| Cap | option is chosen, some of the Inputs will automatically be pre-selected. |
| Pricing Module | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | The pre-selected inputs cannot be changed by the user once this module is |
| | chosen; to change any of these pre-selected inputs, the user should re-select |
| | another Pricing Module. |
| REGULAR | This option allows the user to price only regular Floor structures. When this |
| Floor | option is chosen, some of the inputs will automatically be pre-selected. |
| Pricing Module | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | The pre-selected inputs cannot be changed by the user once this module is |
| | chosen; to change any of these pre-selected inputs, the user should re-select |
| | another Pricing Module. |
| REGULAR | This option allows the user to price only regular Collar structures. RMS |
| Collar | will automatically create a Cap Leg and Floor Leg for the user. The user can |
| Pricing Module | then choose to either buy the Cap and simultaneously sell the Floor or vice |
| | versa. When this option is chosen, some of the inputs will automatically be |
| | pre-selected. |
| | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | In addition to sharing the above attributes, both the Cap and Floor Legs will |
| | also share the same Tenor, same Base Currency and the same Cashflow |
| | Frequency. |
| | The pre-selected inputs cannot be changed by the user once this module is |
| | chosen; to change any of these pre-seleoted inputs, the user should re-select |
| | another Pricing Module. |
| REGULAR | This option allows the user to price only regular Cap Spread structures. |
| Cap Spread | RMS will automatically create two Cap Legs for the user. The user can then |
| Pricing Module | choose to either buy the first Cap and simultaneously sell the second Cap or |
| | vice versa. When this option is chosen, some of the inputs will automatically |
| | be pre-selected. |
| | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | In addition to sharing the above attributes, both the Cap Legs will also share |
| | the same Tenor, same Base Currency and the same Cashflow Frequency. |
| | The pre-selected inputs cannot be changed by the user once this module is |
| | chosen; to change any of these pre-selected inputs, the user should re-select |
| | another Pricing Module. |
| REGULAR | This option allows the user to price only regular Floor Spread structures. |
| Floor Spread | RMS will automatically create two Floor Legs for the user. The user can then |
| Pricing Module | choose to either buy the first Floor and simultaneously sell the second Floor |
| | or vice versa. When this option is chosen, some of the inputs will |
| | automatically be pre-selected. |
| | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | In addition to sharing the above attributes, both the Floor Legs will also share |
| | the same Tenor, same Base Currency and the same Cashflow Frequency. |
| | The pre-selected inputs cannot be changed by the user once this module is |
| | chosen; to change any of these pre-selected inputs, the user should re-select |
| | another Pricing Module. |
| REGULAR | This option allows the user to price only regular Digital Cap structures. When |
| Digital Cap | this option is chosen, some of the inputs will automatically be pre-selected. |
| Pricing Module | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | The pre-selected inputs cannot be changed by the user once this module is |
| | chosen; to change any of these pre-selected inputs, the user should re-select |
| | another Pricing Module. |
| REGULAR | This option allows the user to price only regular Digital Floor structures. |
| Digital Floor | When this option is chosen, some of the inputs will automatically be pre- |
| Pricing Module | selected. |
| | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | The pre-selected inputs cannot be changed by the user once this module is |
| | chosen; to change any of these pre-selected inputs, the user should re-select |
| | another Pricing Module. |
| REGULAR | This option allows the user to price only regular Digital Collar structures. |
| Digital Collar | RMS will automatically create a Digital Cap Leg and a Digital Floor Leg for |
| Pricing Module | the user. The user can then choose to either buy the Digital Cap and |
| | simultaneously sell the Digital Floor or vice versa. When this option is |
| | chosen, some of the inputs will automatically be pre-selected. |
| | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | In addition to sharing the above attributes, both the Digital Cap and Digital |
| | Floor Legs will also share the same Tenor, same Base Currency and the |
| | same Cashflow Frequency. |
| | The pre-selected inputs cannot be changed by the user once this module is |
| | chosen; to change any of these pre-selected inputs, the user should re-select |
| | another Pricing Module. |
| REGULAR | This option allows the user to price only regular Digital Cap Spread |
| Digital Cap Spread | structures. RMS will automatically create two Digital Cap Legs for the |
| Pricing Module | user. The user can then choose to either buy the first Digital Cap and |
| | simultaneously sell the second Digital Cap or vice versa. When this option is |
| | chosen, some of the inputs will automatically be pre-selected. |
| | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | In addition to sharing the above attributes, both the Digital Cap Legs will also |
| | share the same Tenor, same Base Currency and the same Cashflow |
| | Frequency. |
| | The pre-selected inputs cannot be changed by the user once this module is |
| | chosen; to change any of these pre-selected inputs, the user should re-select |
| | another Pricing Module. |
| REGULAR | This option allows the user to price only regular Digital Floor Spread |
| Digital Floor Spread | structures. RMS will automatically create two Digital Floor Legs for the user. |
| Pricing Module | The user can then choose to either buy the first Digital Floor and |
| | simultaneously sell the second Digital Floor or vice versa. When this option is |
| | chosen, some of the inputs will automatically be pre-selected. |
| | The pre-selected inputs are: |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | In addition to sharing the above attributes, both the Digital Floor Legs will |
| | also share the same Tenor, same Base Currency and the same Cashflow |
| | Frequency. |
| | The pre-selected inputs cannot be changed by the user once this module is |
| | chosen; to change any of these pre-selected inputs, the user should re-select |
| | another Pricing Module. |
| EXOTIC | This option allows the user to price exotic Cap structures. When this option |
| Cap | is chosen, none of the inputs will be pre-selected. The user is free to |
| Pricing Module | specify the full structure of the exotic Cap. |
| EXOTIC | This option allows the user to price exotic Floor structures. When this option |
| Floor | is chosen, none of the inputs will be pre-selected. The user is free to |
| Pricing Module | specify the full structure of the exotic Floor. |
| EXOTIC | This option allows the user to price exotic Collar structures. RMS will |
| Collar | automatically create a Cap Leg and Floor Leg for the user. The user can then |
| Pricing Module | choose to either buy the Cap and simultaneously sell the Floor or vice versa. |
| | When this option is chosen, none of the inputs will be pre-selected. The |
| | user is free to specify the full structure of the exotic Collar. |
| EXOTIC | This option allows the user to price exotic Cap Spread structures. RMS |
| Cap Spread | will automatically create two Cap Legs for the user. The user can then |
| Pricing Module | choose to either buy the first Cap and simultaneously sell the second Cap or |
| | vice versa. When this option is chosen, none of the inputs will be pre- |
| | selected. The user is free to specify the full structure of the exotic Cap |
| | Spread. |
| EXOTIC | This option allows the user to price exotic Floor Spread structures. RMS |
| Floor Spread | will automatically create two Floor Legs for the user. The user can then |
| Pricing Module | choose to either buy the first Floor and simultaneously sell the second Floor |
| | or vice versa. When this option is chosen, none of the inputs will be pre- |
| | selected. The user Is free to specify the full structure of the exotic Floor |
| | Spread. |
| EXOTIC | This option allows the user to price exotic Digital Cap structures. When this |
| Digital Cap | option is chosen, none of the inputs will be pre-selected. The user is free to |
| Pricing Module | specify the full structure of the exotic Digital Cap. |
| EXOTIC | This option allows the user to price exotic Digital Floor structures. When this |
| Digital Floor | option is chosen, none of the inputs will be pre-selected. The user is free to |
| Pricing Module | specify the full structure of the exotic Digital Floor. |
| EXOTIC | This option allows the user to price exotic Digital Collar structures. RMS will |
| Digital Collar | automatically create a Digital Cap Leg and a Digital Floor Leg for the user. |
| Pricing Module | The user can then choose to either buy the Digital Cap and simultaneously |
| | sell the Digital Floor or vice versa. When this option is chosen, none of the |
| | inputs will be pre-selected. The user is free to specify the full structure of |
| | the exotic Digital Collar. |
| EXOTIC | This option allows the user to price exotic Digital Cap Spread structures. |
| Digital Cap Spread | RMS will automatically create two Digital Cap Legs for the user. The user |
| Pricing Module | can then choose to either buy the first Digital Cap and simultaneously sell the |
| | second Digital Cap or vice versa. When this option is chosen, none of the |
| | inputs will be pre-selected. The user is free to specify the full structure of the |
| | exotic Digital Cap Spread. |
| EXOTIC | This option allows the user to price exotic Digital Floor Spread structures. |
| Digital Floor Spread | RMS will automatically create two Digital Floor Legs for the user. The user |
| Pricing Module | can then choose to either buy the first Digital Floor and simultaneously sell |
| | the second Digital Floor or vice versa. When this option is chosen, none of |
| | the inputs will be pre-selected. The user is free to specify the full structure of |
| | the exotic Digital Floor Spread. |

TABLE 4
Platform (Swaptions)

| | |
|---|---|
| Regular Payer | This option allows the user to price only regular Payer Interest Rate Swap |
| Swaption | Option structures. When this option is chosen, some of the inputs will |
| Pricing Module | automatically be pre-selected. |
| | The pre-selected inputs are: |
| | Base Currency (Leg 2): Will be set to Base Currency (Leg 1) |
| | Notional Amount (Leg 2): Will be set to Notional Amount (Leg 1) |
| | Interest Movements: At The End. |
| | LIBOR Selling Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | The pre-selected inputs cannot be changed by the user once this module is |
| | chosen; to change any of these pre-selected inputs, the user should re-select |
| | another Pricing Module. |
| Regular Receiver | This option allows the user to price only regular Receiver Interest Rate Swap |
| Swaption | Option structures. When this option is chosen, some of the inputs will |
| Pricing Module | automatically be pre-selected. |
| | The pre-selected inputs are: |
| | Base Currency (Leg 2): Will be set to Base Currency (Leg 1) |
| | Notional Amount (Leg 2): Will be set to Notional Amount (Leg 1) |
| | Interest Movements: At The End. |
| | LIBOR Setting Time: At The Beginning. |
| | LIBOR Currency Base: Will be set to the Base Currency. |
| | LIBOR Basis: Will be set to follow Cashflow Frequency. |
| | Stub LIBOR Handling Procedure: Will be set to Standard. |
| | DayCount Convention: Will be set to the DayCount Convention of the |
| | underlying Base Currency. |
| | The pre-selected inputs cannot be changed by the user once this module is |
| | chosen; to change any of these pre-selected inputs, the user should re-select |
| | another Pricing Module. |

TABLE 5
Platform (C/F Analysis)

| | |
|---|---|
| Term Deposit | This option allows the user to price only regular Term Deposit structures. |
| Pricing Module | When this option is chosen, some of the inputs will automatically be pre- |
| | selected. |
| | The pre-selected inputs are: |
| | Interest Movements: At The End. |
| | Interest Mode: Fixed. |
| | The pre-selected inputs cannot be changed by the user once this module is |
| | chosen; to change any of these pre-selected inputs, the user should re-select |
| | another Pricing Module. |
| Money Market Swap | This option allows the user to price only regular Money Market Swap |
| Pricing Module | structures. When this option is chosen, some of the inputs will automatically |
| | be pre-selected. |
| | The pre-selected inputs are: |
| | Principal Exchange At Start: YES. |
| | Principal Exchange At Maturity: YES. |
| | The pre-selected inputs cannot be changed by the user once this module is |
| | chosen; to change any of these pro-selected inputs, the user should re-select |
| | another Pricing Module. |
| Cash Flow Analysis | This option allows the user to analyse single-currency cashflow types that do |
| Pricing Module | not normally occur in instruments found in any of the other RMS platforms. |
| | When this option is chosen, none of the inputs will be pre-selected. |

TABLE 6
Platform (Vanilla Options)

| | |
|---|---|
| Structuring and | This option allows the user to price all types of vanilla option structures, i.e., |
| Pricing Module | user is free to specify the option structure. |
| | None of the inputs are pre-selected. |
| Long Call | This option allows the user to price only a Long Call position. When this |
| Pricing Module | option is chosen, some of the inputs will automatically be pre-selected. |
| | The pre-selected inputs are: |
| | Leg 1—Buy a European Call option, |
| | whereby the user is free to choose the strike level. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Short Call | This option allows the user to price only a Short Call position. When this |
| Pricing Module | option is chosen, some of the inputs will automatically be pre-selected. |
| | The pre-selected inputs are: |
| | Leg 1—Sell a European Call option, |
| | whereby the user is free to choose the strike level. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Long Put | This option allows the user to price only a Long Put position. When this |
| Pricing Module | option is chosen, some of the inputs will automatically be pre-selected. |
| | The pre-selected inputs are: |
| | Leg 1—Buy a European Put option, |
| | whereby the user is free to choose the strike level. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Short Put | This option allows the user to price only a short put position. When this |
| Pricing Module | option is chosen, some of the inputs will automatically be pre-selected. |
| | The pre-selected inputs are: |
| | Leg 1—Sell a European Put option, |
| | whereby the user is free to choose the strike level. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Bull Spread (with | This option allows the user to price only a Bull Spread position. When this |
| Calls) | option is chosen, some of the inputs will automatically be pre-selected. |
| Pricing Module | The pre-selected inputs are: |
| | Leg 1—Buy a European Call option (with strike K₁), |
| | Leg 2—Sell a European Call option (with strike K₂), |
| | whereby the user is free to choose the strike levels such that K₁ ≦ K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Bull Spread (with | This option allows the user to price only a Bull Spread position. When this |
| Puts) | option is chosen, some of the inputs will automatically be pre-selected. |
| Pricing Module | The pre-selected inputs are: |
| | Leg 1—Buy a European Put option (with strike K₁), |
| | Leg 2—Sell a European Put option (with strike K₂), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Bear Spread (with | This option allows the user to price only a Bear Spread position. When this |
| Calls) | option is chosen, some of the inputs will automatically be pre-selected. |
| Pricing Module | The pre-selected inputs are: |
| | Leg 1—Buy a European Call option (with strike K₂), |
| | Leg 2—Sell a European Call option (with strike K₁), |
| | whereby the user is free to choose the strike levels K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Bear Spread (with | This option allows the user to price only a Bear Spread position. When this |
| Puts) | option is chosen, some of the inputs will automatically be pre-selected. |
| Pricing Module | The pre-selected inputs are: |
| | Leg 1—Buy a European Put option (with strike K₂), |
| | Leg 2—Sell a European Put option (with strike K₁), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Long Butterfly (with | This option allows the user to price only a Long Butterfly position. When this |
| Calls) | option is chosen, some of the inputs will automatically be pre-selected. |
| Pricing Module | The pre-selected inputs are: |
| | Leg 1—Buy 1 × European Call option (with strike K₁), |
| | Leg 2—Sell 2 × European Call options (with strike K₂), |
| | Leg 3—Buy 1 × European Call option (with strike K₃), |
| | whereby the user is free to choose the strike levels such that K₁ < K₂ < K₃. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Long Butterfly (with | This option allows the user to price only a Long Butterfly position. When this |
| Puts) | option is chosen, some of the inputs will automatically be pre-selected. |
| Pricing Module | The pre-selected inputs are: |
| | Leg 1—Buy 1 × European Put option (with strike K₁), |
| | Leg 2—Sell 2 × European Put options (with strike K₂), |
| | Leg 3—Buy 1 × European Put option (with strike K₃), |
| | whereby the user is free to choose the strike levels such that K₁ < K₂ < K₃. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Short Butterfly (with | This option allows the user to price only a Short Butterfly position. When this |
| Calls) | option is chosen, some of the inputs will automatically be pre-selected. |
| Pricing Module | The pre-selected inputs are: |
| | Leg 1—Sell 1 × European Call option (with strike K₁), |
| | Leg 2—Buy 2 × European Call options (with strike K₂), |
| | Leg 3—Sell 1 × European Call option (with strike K₃), |
| | whereby the user is free to choose the strike levels such that K₁ < K₂ < K₃. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Short Butterfly (with | This option allows the user to price only a Short Butterfly position. When this |
| Puts) | option is chosen, some of the inputs will automatically be pre-selected. |
| Pricing Module | The pre-selected inputs are: |
| | Leg 1—Sell 1 × European Put option (with strike K₁), |
| | Leg 2—Buy 2 × European Put options (with strike K₂), |
| | Leg 3—Sell 1 × European Put option (with strike K₃), |
| | whereby the user is free to choose the strike levels such that K₁ < K₂ < K₃. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| The Big W | This option allows the user to price only a Big W position. When this option |
| Pricing Module | is chosen, some of the inputs will automatically be pre-selected. |
| | The pre-selected inputs are: |
| | Leg 1—Buy 2 × European Put options (with strike K₁), |
| | Leg 2—Sell 1 × European Put option (with strike K₂), |
| | Leg 3—Sell 1 × European Call option (with strike K₂), |
| | Leg 4—Buy 2 × European Call options (with strike K₃), |
| | whereby the user is free to choose the strike levels such that K₁ < K₂ < K₃. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| The Big M | This option allows the user to price only a Big M position. When this option is |
| Pricing Module | chosen, some of the inputs will automatically be pre-selected. |
| | The pre-selected inputs are: |
| | Leg 1—Sell 2 × European Put options (with strike K₁), |
| | Leg 2—Buy 1 × European Put option (with strike K₂), |
| | Leg 3—Buy 1 × European Call option (with strike K₂), |
| | Leg 4—Sell 2 × European Call options (with strike K₃), |
| | whereby the user is free to choose the strike levels such that K₁ < K₂ < K₃. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Long Condor (with | This option allows the user to price only a Long Condor position. When this |
| Calls) | option is chosen, some of the inputs will automatically be pre-selected. |
| Pricing Module | The pre-selected inputs are: |
| | Leg 1—Buy a European Call option (with strike K₁), |
| | Leg 2—Sell a European Call option (with strike K₂), |
| | Leg 3—Sell a European Call option (with strike K₃), |
| | Leg 4—Buy a European Call option (with strike K₄), |
| | whereby the user is free to choose the strike levels such that K₁ < K₂ < K₃ < |
| | K₄. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Long Condor (with | This option allows the user to price only a Long Condor position. When this |
| Puts) | option is chosen, some of the inputs will automatically be pre-selected. |
| Pricing Module | The pre-selected inputs are: |
| | Leg 1—Buy a European Put option (with strike K₁), |
| | Leg 2—Sell a European Put option (with strike K₂), |
| | Leg 3—Sell a European Put option (with strike K₃), |
| | Leg 4—Buy a European Put option (with strike K₄), |
| | whereby the user is free to choose the strike levels such that K₁ < K₂ < K₃ < |
| | K₄. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Short Condor (with | This option allows the user to price only a Short Condor position. When this |
| Calls) | option is chosen, some of the inputs will automatically be pre-selected. |
| Pricing Module | The pre-selected inputs are: |
| | Leg 1—Sell a European Call option (with strike K₁), |
| | Leg 2—Buy a European Call option (with strike K₂), |
| | Leg 3—Buy a European Call option (with strike K₃), |
| | Leg 4—Sell a European Call option (with strike K₄), |
| | whereby the user is free to choose the strike levels such that K₁ < K₂ < K₃ < |
| | K₄. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Short Condor (with | This option allows the user to price only a Short Condor position. When this |
| Puts) | option is chosen, some of the inputs will automatically be pre-selected. |
| Pricing Module | The pre-selected inputs are: |
| | Leg 1—Sell a European Put option (with strike K₁), |
| | Leg 2—Buy a European Put option (with strike K₂), |
| | Leg 3—Buy a European Put option (with strike K₃), |
| | Leg 4—Sell a European Put option (with strike K₄), |
| | whereby the user is free to choose the strike levels such that K₁ < K₂ < K₃ < |
| | K₄. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Long Straddle | This option allows the user to price only a Long Straddle position. When this |
| Pricing Module | option is chosen, some of the inputs will automatically be pre-selected. |
| | The pre-selected inputs are: |
| | Leg 1—Buy a European Call option (with strike K), |
| | Leg 2—Buy a European Put option (with strike K), |
| | whereby the user is free to choose the strike level K. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Short Straddle | This option allows the user to price only a Short Straddle position. When this |
| Pricing Module | option is chosen, some of the inputs will automatically be pre-selected. |
| | The pre-selected inputs are: |
| | Leg 1—Sell a European Call option (with strike K), |
| | Leg 2—Sell a European Put option (with strike K), |
| | whereby the user is free to choose the strike level K. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Long Strangle | This option allows the user to price only a Long Strangle position. When this |
| Pricing Module | option is chosen, some of the inputs will automatically be pre-selected. |
| | The pre-selected inputs are: |
| | Leg 1—Buy a European Call option (with strike K₂), |
| | Leg 2—Buy a European Put option (with strike K₁), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Short Strangle | This option allows the user to price only a Short Strangle position. When this |
| Pricing Module | option is chosen, some of the inputs will automatically be pre-selected. |
| | The pre-selected inputs are: |
| | Leg 1—Sell a European Call option (with strike K₂), |
| | Leg 2—Sell a European Put option (with strike K₁), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Long Combination | This option allows the user to price only a Long Combination position. When |
| Pricing Module | this option is chosen, some of the inputs will automatically be pre-selected. |
| | The pre-selected inputs are: |
| | Leg 1—Buy a European Call option (with strike K₁), |
| | Leg 2—Buy a European Put option (with strike K₂), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Short Combination | This option allows the user to price only a Short Combination position. When |
| Pricing Module | this option is chosen, some of the inputs will automatically be pre-selected. |
| | The pre-selected inputs are: |
| | Leg 1—Sell a European Call option (with strike K₁), |
| | Leg 2—Sell a European Put option (with strike K₂), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Call Ratio Spread | This option allows the user to price only a Call Ratio position. When this |
| Pricing Module | option is chosen, some of the inputs will automatically be pre-selected. |
| | The pre-selected inputs are: |
| | Leg 1—Buy 1 × European Call option (with strike K₁), |
| | Leg 2—Sell m × European Call options (with strike K₂), |
| | whereby the user is free to choose the strike levels such that K₁ < K₂ and |
| | m > 1. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Put Ratio Spread | This option allows the user to price only a Put Ratio position. When this |
| Pricing Module | option is chosen, some of the inputs will automatically be pre-selected. |
| | The pre-selected inputs are: |
| | Leg 1—Buy 1 × European Put option (with strike K₂), |
| | Leg 2—Sell n × European Put options (with strike K₁), |
| | whereby the user is free to choose the strike levels such that K₁ < K₂ and |
| | n > 1. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Gall Ratio Back- | This option allows the user to price only a Call Ratio Backspread position. |
| Spread | When this option is chosen, some of the inputs will automatically be pre- |
| Pricing Module | selected. |
| | The pre-selected inputs are: |
| | Leg 1—Buy m × European Call options (with strike K₂), |
| | Leg 2—Sell 1 × European Call option (with strike K₁), |
| | whereby the user is free to choose the strike levels such that K₁ < K₂ and |
| | m > 1. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Put Ratio Back- | This option allows the user to price only a Put Ratio Backspread position. |
| Spread | When this option is chosen, some of the inputs will automatically be pre- |
| Pricing Module | selected. |
| | The pre-selected inputs are: |
| | Leg 1—Buy n × European Put options (with strike K₁), |
| | Leg 2—Sell 1 × European Put option (with strike K₂), |
| | whereby the user is free to choose the strike levels such that K₁ < K₂ and |
| | n > 1. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Right Spoke | This option allows the user to price only a Right Spoke position. When this |
| (with Multi-Calls) | option is chosen, some of the inputs will automatically be pre-selected. |
| Pricing Module | The pre-selected inputs are: |
| | Leg 1—Sell 1 × European Put option (with strike K₁), |
| | Leg 2—Sell 1 × European Call option (with strike K₁), |
| | Leg 3—Buy 2 × European Call options (with strike K₂), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Right Spoke | This option allows the user to price only a Right Spoke position. When this |
| (with Multi-Puts) | option is chosen, some of the inputs will automatically be pre-selected. |
| Pricing Module | The pre-selected inputs are: |
| | Leg 1—Sell 2 × European Put options (with strike K₁), |
| | Leg 2—Buy 1 × European Call option (with strike K₂), |
| | Leg 3—Buy 1 × European Put option (with strike K₂), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Left Spoke | This option allows the user to price only a Left Spoke position. When this |
| (with Multi-Calls) | option is chosen, some of the inputs will automatically be pre-selected. |
| Pricing Module | The pre-selected inputs are: |
| | Leg 1—Buy 1 × European Put option (with strike K₁), |
| | Leg 2—Buy 1 × European Call option (with strike K₁), |
| | Leg 3—Sell 2 × European Call options (with strike K₂), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Left Spoke | This option allows the user to price only a Left Spoke position. When this |
| (with Multi-Puts) | option is chosen, some of the inputs will automatically be pre-selected. |
| Pricing Module | The pre-selected inputs are: |
| | Leg 1—Buy 2 × European Put options (with strike K₁), |
| | Leg 2—Sell 1 × European Call option (with strike K₂), |
| | Leg 3—Sell 1 × European Put option (with strike K₂), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Long Risk-Reversal | This option allows the user to price only a Long Risk-Reversal position. |
| Pricing Module | When this option is chosen, some of the inputs will automatically be pre- |
| | selected. |
| | The pre-selected inputs are: |
| | Leg 1—Buy a European Call option (with strike K₂), |
| | Leg 2—Sell a European Put option (with strike K₁), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |
| Short Risk-Reversal | This option allows the user to price only a Short Risk-Reversal position. |
| Pricing Module | When this option is chosen, some of the inputs will automatically be pre- |
| | selected. |
| | The pre-selected inputs are: |
| | Leg 1—Buy a European Put option (with strike K₁), |
| | Leg 2—Sell a European Call option (with strike K₂), |
| | whereby the user is free to choose the strike levels such that K₁ < K₂. |
| | All legs share the same expiry and delivery dates. |
| | The pre-selected inputs cannot be changed by the user once this module is |
| | chosen and no adding or deleting of option legs is allowed; to make changes |
| | to any of the above pre-selected inputs, the user should re-select another |
| | Pricing Module. |

TABLE 7
Platform (Exotic Options)

| | |
|---|---|
| Structuring and | This option allows the user to price all types of vanilla |
| Pricing Module | and exotic option structures, i.e., user is free to specify |
| | the option structure. |
| | None of the Inputs are pre-selected. |

RMS Pricing Methodology

The methodology for pricing the various financial instruments is well known In the arts, and this known methodology is generally employed by the present invention. Particularly, however, the RMS methodology can conceptually be divided into three phases.

In the first phase, the user first provides all primary inputs, like the type of Financial Instrument he wishes to price, the desired Start and Maturity dates, the Base Currencies, the Notional Amounts, the desired Business Day Convention (which is defaulted to the “Modified Following” at the start of the platform), Position, Cashflow Frequency, Stub Handling, . . . , DayCount Convention etc. Once RMS has all the primary input information, the first step of the processing begins with the user clicking on the “Generate Cashflows” button.

From the Base Currencies and the Position inputs, RMS Is able to choose precisely the discount curves required to calculate the present values of the cashflows occurring in the respective base currencies. If there is only one base currency specified for both legs say, then clearly RMS will choose only the IRS type discount curve for that base currency. On the other hand, if the base currencies are different, then RMS will choose the CCS type discount curve for each of the base currencies, as the structure is of a cross currency nature. The “Position” input indicates to RMS whether it should use the bid or offer side of the specific discount curve in its computations.

The Start Date and the Maturity Date inputs together with the Frequency input and the Stub Handling input (if there is any Stub period for the structure) are sufficient for RMS to generate the cashflow periods and the cashflow dates. These dates are adjusted for holidays according to the Business Day Convention chosen. The generated dates appear on each of the Leg Tab-sheets.

In the second phase, if the structure is “Regular”, then it is possible the primary inputs are sufficient for RMS to continue its processing without requiring secondary inputs. If however the structure is “non-Regular”, for example if the principal amounts change in the course of the instrument life like in an Amortizing or Roller-coaster Swap, then the user is required to provide inputs in the Notional Adjustments column, or as another example, if additional cashflows are part of the structure, then inputs need to be provided in the Additional Cashflows column. The Notional Adjustments inputs and the Additional Cashflow inputs are part of secondary inputs. Notice that the above are examples of Regular instruments that require secondary inputs.

In the case of Exotic structures, it is clear that in almost all cases, the user will be required to provide secondary inputs. If the Interest Mode is set to “Floating”, then RMS will require the user to provide further inputs in the Interest Rates Details Box. RMS will need to know what the LIBOR Currency Base, LIBOR Basis and Stub LIBOR Handling Procedure (if there is a Stub period in the structure) inputs are. These inputs are essential in allowing RMS to work out the LIBOR “proxies”. For example, if the benchmark rate in a particular instrument is the 2-month JPY LIBOR, then the user will input “JPY” as the LIBOR Currency Base, “2-month” as the LIBOR Basis, and assuming there is a Stub Period of 20 days in the Structure and “Standard” is chosen for Stub LIBOR Handling Procedure, then in this case RMS will work out a interpolated 20-day JPY LIBOR rate from the JPY Discount Factor Offer Curve and use it for the Stub period interest rate calculations, and work out the respective 2-month LIBOR proxies for the remaining periods in the structure using the same Discount Factor curve.

In any of the above calculations involving Discount Factor curves, if a date does not fall on a grid-point date, the discount factor for that particular point is then calculated using exponential interpolation on the discount factors of the two surrounding grid-points. The LIBOR proxy is then easily calculated using the standard formula, given the two discount factors of the period start and end dates.

Once all the required inputs at the second phase level have been provided by the user, RMS will continue in its processing. It takes all the above information provided and generates all the relevant cashflow, i.e., interest and principal movements, sums them up with any additional cashflows, and then converts the sum to present values using the relevant Base Currency Discount Factors. RMS then calculates the sum of these present values and displays the result as the NPV (“Net Present Value”) on the Results Summary Tabsheet. The user can choose at this stage of the processing to either save the structure as a structure or as a deal done.

In the third phase, the user can also choose to continue with the processing to compute the sensitivity variables. If the user chooses to continue with the processing, then RMS will take each of the grid-points on each of the yield curves which have been used in the processing so far and shift the yield levels up and down (keeping all other grid-point yields unchanged) and compute the NPV values at these shifted levels. The grid-point sensitivity variables are then computed using the approximation formula for deltas and gammas accordingly and by using the NPVs calculated in the above shifting process. The user can then return to the main platform and choose to either save the structure as a structure or as a deal.

RMS requires the discount factor curves (and the yield curves) to be running in the “background” before it performs the calculations for the various platforms. Therefore, before one can start working on the pricing platforms, one has to first build the required curves. The discount factor curves are the actual working curves, i.e., RMS uses the generated results from these curves for computational purposes in the various Platforms. The yield curves on the other hand are purely for display purposes only.

As a matter of definition, an n-year zero-coupon yield is the interest rate earned for n-years without any interim cashflow. A zero-coupon yield curve is then defined as a collection of connected discrete yields at a given number of tenor points. A discount factor for a given tenor is simply the “today's” or spot price of a zero-coupon $1 bond with the corresponding tenor. A discount factor curve is then defined as a collection of connected discrete discount factors at a given number of tenor points.

While there are several conventions in the financial markets, RMS quotes the yields for all currencies based on the 365 days in a year basis (regardless of leap years) and assuming annual compounding.

Discount Factor (and Yield) curves can be built using inputs from several instruments. RMS uses inputs from money market deposits, money market swaps, futures, long-term interest rate swaps and cross currency swaps.

For each of the currencies other than the USD, RMS builds two types of Discount Factor (and Yield) curves—The IRS (“Interest Rate Swap”) curve and the CCS (“Cross Currency Swap”) Curve. For the USD however, RMS builds only one type of Discount Factor (and Yield) curves—The IRS (“Interest Rate Swap”) curve.

The building a separate CCS curve to price cross currency interest rate structures is a new method employed by the present Invention. Almost all market participants price their interest rate instruments using only one type of curve. They simply make adjustments or “twitch” the curve accordingly to price cross currency interest rate instruments. One needs to be fairly expert to price instruments In such a way. The purpose of creating this “new” type of curve is to allow a constant maintenance of a curve which can be readily used to price cross currency interest rate structures, rather than requiring the user to constantly have to make adjustments in the usual case.

The IRS Curve is built using money markets deposits, futures (for some of the currencies) and long-term interest rate swaps. The CCS Curve on the other hand is built using money market swaps (which are quoted against the USD), futures (for some of the currencies) and long-term cross currency swaps (which are quoted against the USD).

The IRS Curves are used primarily for valuing single base currency interest rate instruments, whilst the CCS Curves are used for valuing cross currency interest rate instruments.

Both types of curves are built using the standard “bootstrapping” methodology. However, to build the CCS curve, some additional steps are taken by RMS. It has to first convert the money market swap rates to implied base currency deposit rates from USD money market deposit rates. For some currencies, Cross Currency Swap rates quoted against the USD already exist. If they do not exist directly, then these rates are obtained from the combination of the base currency interest rate swap rates and the basis risk quotes for USD/Base Currency. Once these rates have been computed, the regular “bootstrapping” methodology (as used in building the IRS curves) is applied using the implied money market deposit rates, futures (for some of the currencies) and the cross currency swap rates.

In order to determine non-grid points, the Exponential Interpolation technique is used on the discount factor curve, whilst for the yield curve, the simple linear interpolation technique is applied.

For each of the types of curves, i.e., the IRS or the CCS, RMS maintains a bid and offer curve. In other words, with the exception of the USD currency which only has the IRS bid and offer curves, all other currencies have both the bid and off IRS and the bid and offer CCS curves.

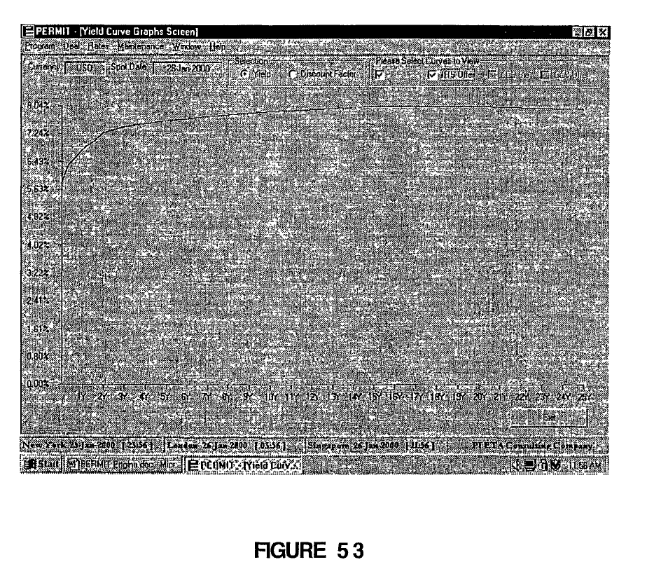

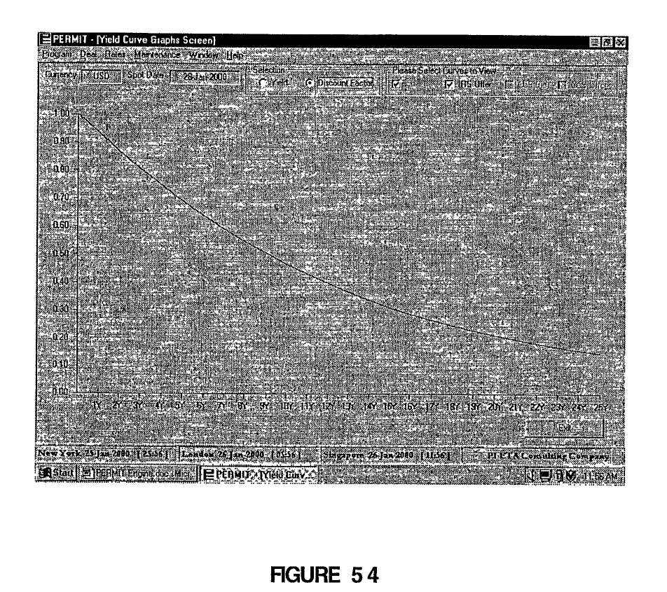

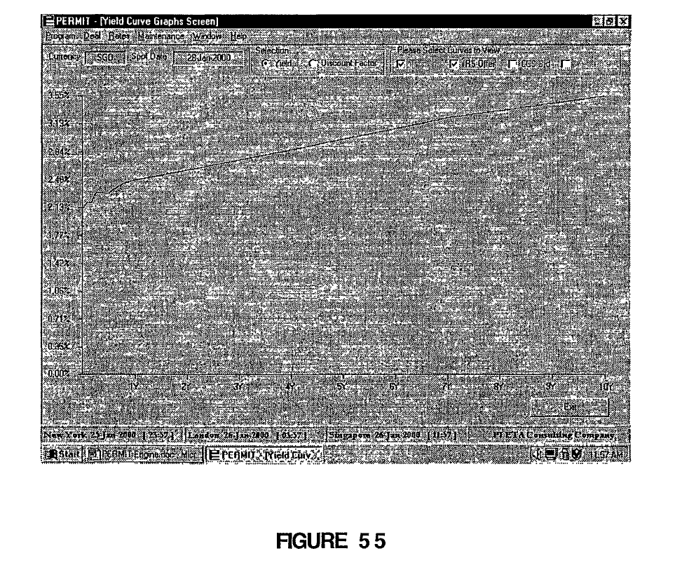

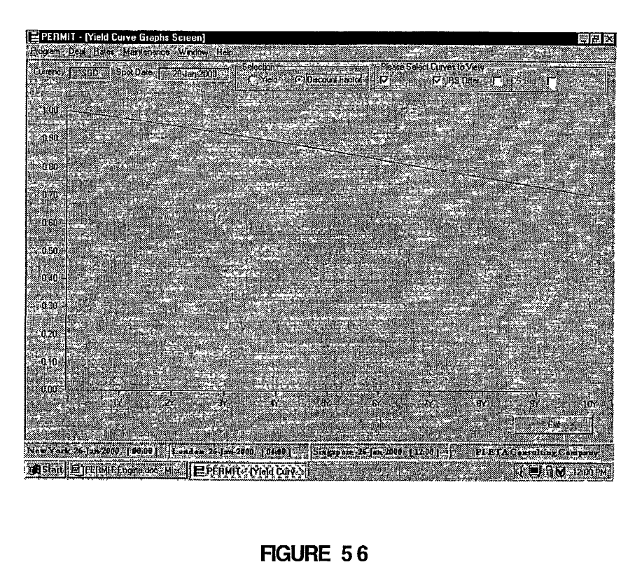

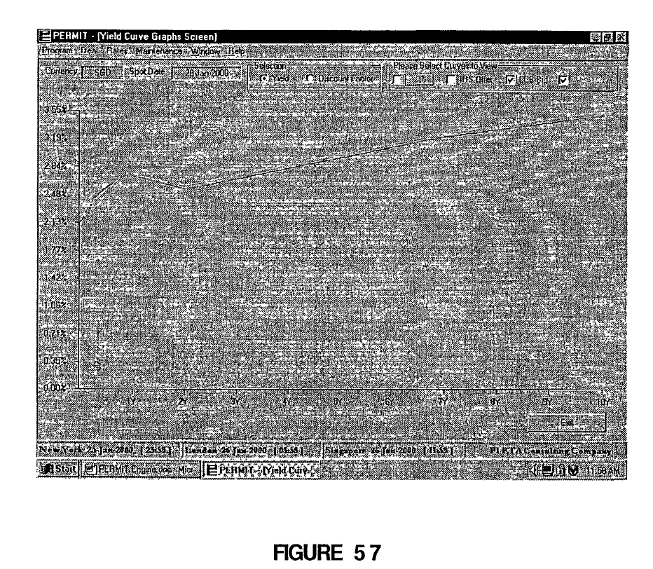

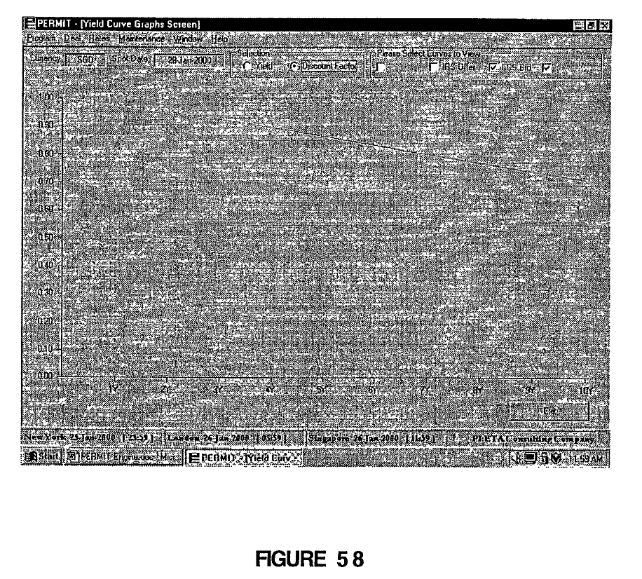

FIG. 53 illustrates a sample bid/offer USD IRS yield curve generated by the present system. FIG. 54 Illustrates a sample bid/offer USD IRS discount factor curves generated by the present system. FIG. 55 illustrates a sample bid/offer SGD IRS yield curve generated by the present system. FIG. 56 illustrates a sample bid/offer SGD IRS discount factor curve generated by the present system. FIG. 57 illustrates a sample bid/offer SGD CCS yield curve generated by the present system. FIG. 58 illustrates a sample bid/offer SGD CCS discount factor curve generated by the present system.

The present system may run on any conventional computer having a display, an input device such as a mouse and/or keyboard, sufficient memory and processing power.

The present invention may be embodied in other specific forms without departing from the spirit or essential characteristics thereof. The presently disclosed embodiments are, therefore, to be considered in all respects as illustrative and not restrictive, the scope of the invention being indicated by the appended claims and all changes which come within the meaning and range of equivalency of the claims are, therefore, to be embraced therein.

I claim:

1. A data base system for pricing and structuring financial instruments comprising:
a means for computing a yield curve;
a means for computing a discount factor curve;
a first graphic user interface for entering primary inputs, said first graphic user interface providing defined primary input fields, said primary input fields being either pre-fixed or not fixed depending on a financial instrument selected;
a means for generating and displaying cash flows;
a second graphic user interface for entering secondary inputs, said second user interface providing defined secondary input fields, said secondary input fields being either pre-fixed or not fixed depending on a financial instrument selected;
a means for calculating net present value;
a storage means for storing data associated with said selected financial instrument.

2. The database system as recited in claim 1 further comprising a means for computing sensitivity.

3. The database system as recited in claim 1 wherein said data can be stored as a deal or as a structure.

4. A data base system for pricing and structuring exotic forward rate agreements comprising:
a means for computing a yield curve;
a means for computing a discount factor curve; and
a means for setting a interest mode to reverse floating.
